(19) United States
(12) Patent Application Publication
(10) Pub. No.: US 2014/0197797 A1
(43) Pub. Date: Jul. 17, 2014

(54) ELECTROCHEMICAL DEVICE

(71) Applicant: SEMICONDUCTOR ENERGY LABORATORY CO., LTD., Atsugi-shi (JP)

(72) Inventor: Shunpei YAMAZAKI, Tokyo (JP)

(73) Assignee: SEMICONDUCTOR ENERGY LABORATORY CO., LTD., Atsugi-shi (JP)

(21) Appl. No.: 14/153,510

(22) Filed: Jan. 13, 2014

(30) Foreign Application Priority Data
Jan. 14, 2013 (JP) 2013-004160
Feb. 20, 2013 (JP) 2013-031147

(51) Int. Cl. H02J 7/00

(52) U.S. Cl. CPC H02J 7/0029; H02J 7/0068
USPC 320/128; 429/209

(57) ABSTRACT

To prevent deterioration of a battery or reduce the degree of deterioration of a battery and to maximize charge and discharge performance of the battery and maintain charge and discharge performance of the battery for a long time. A reaction product formed on an electrode surface causes various malfunctions and deterioration of a battery typified by a lithium-ion secondary battery. The present inventors have found a breakthrough technological idea that a reaction product is prevented from being deposited on an electrode in charging or discharging or a formed reaction product is dissolved by application of an electrical stimulus to an electrochemical device that operates utilizing an electrochemical reaction, typified by a lithium-ion secondary battery. Specifically, the reaction product is dissolved by supplying a signal (inversion pulse current) with which a current flows in the reverse direction of a current with which a reaction product is formed.

### TECHNICAL FIELD

The present invention relates to an object, a method, or a manufacturing method. Alternatively, the present invention relates to a process, a machine, manufacture, or a composition of matter. In particular, the present invention relates to, for example, a power storage device, a semiconductor device, a display device, a light-emitting device, a driving method thereof, or a fabrication method thereof. The present invention relates to, for example, an electrochemical device, an operating method thereof, or a manufacturing method thereof. Alternatively, the present invention relates to a system having a function of reducing the degree of deterioration of an electrochemical device.

Note that an electrochemical device in this specification generally means a device that can operate by utilizing a battery, a conductive layer, a resistor, a capacitor, and the like.

### BACKGROUND ART

Batteries (secondary batteries) are known as a typical example of electrochemical devices. A lithium-ion secondary battery, which is one of batteries, is used in a variety of applications including a power source of a mobile phone, a fixed power source of a residential power storage system, power storage equipment of a power generation facility, such as a solar cell, and the like. Characteristics such as high energy density, excellent cycle characteristics, safety under various operating environments, and long-term reliability are necessary for the lithium-ion secondary battery.

In addition, the lithium-ion secondary battery includes at least a positive electrode, a negative electrode, and an electrolytic solution (Patent Document 1).

### REFERENCE

[Patent Document] Japanese Published Patent Application No. 2012-009418

### DISCLOSURE OF INVENTION

A battery (secondary battery) such as a lithium-ion secondary battery deteriorates due to repeated charge and discharge and the capacity thereof is gradually decreased. The voltage of the battery eventually becomes lower than a voltage in a range where an electronic device including the battery can be used; thus, the battery becomes dysfunctional.

In view of the above, an object of the present invention is to prevent deterioration of a battery or reduce the degree of deterioration of a battery and to maximize charge and discharge performance of the battery and maintain charge and discharge performance of the battery for a long time.

Further, batteries are electrochemical devices whose lifetimes are difficult to estimate individually in advance. There are some defective products which suddenly become dysfunctional because of any cause among batteries charged and discharged without any problem when manufactured and thus shipped as quality products.

Another object of the present invention is to prevent a battery from suddenly being dysfunctional, to secure long-term reliability of each battery, and to improve the long-term reliability. Another object of the present invention is to provide a maintenance-free battery by solving the object. In particular, there is a problem in that the maintenance of a fixed power source or power storage equipment requires considerable cost and time.

Further, there are some defective products which produce heat, expand, ignite, or explode because of any cause among batteries charged and discharged without any problem when manufactured and thus shipped as quality products. Hence, another object of the present invention is to ensure the safety of a battery.

Another object of the present invention is to enable rapid charge and rapid discharge of a battery. Another object of the present invention is to provide a novel charging method or a novel discharging method of a battery. Note that the descriptions of these objects do not disturb the existence of other objects. Note that in one embodiment of the present invention, there is no need to achieve all the objects. Note that other objects will be apparent from and can be derived from the descriptions of the specification, the drawings, the claims, and the like.

A reaction product (also referred to as dross) formed on an electrode surface causes various malfunctions and deterioration of a battery typified by a lithium-ion secondary battery. The present inventors have found a breakthrough technological idea that a reaction product is prevented from being deposited on an electrode in charging or discharging or a formed reaction product is dissolved by application of an electrical stimulus to an electrochemical device that operates utilizing an electrochemical reaction, typified by a lithium-ion secondary battery.

### <Charge and Discharge of Lithium-Ion Secondary Battery>

Here, descriptions will be given of a principle of operation of a lithium-ion secondary battery and a principle of lithium deposition with reference to schematic diagrams in FIGS. 3A and 3B and FIGS. 4A and 4B.

FIG. 3A is a schematic diagram illustrating an electrochemical reaction of a lithium-ion secondary battery at the time of charging. FIG. 4A is a schematic diagram illustrating an electrochemical reaction of a lithium-ion secondary battery at the time of discharging. In FIG. 3A, a reference numeral 501 denotes a lithium-ion secondary battery, and a reference numeral 502 denotes a charger. In FIG. 4A, a reference numeral 503 denotes a load.

As illustrated in FIG. 3A and FIG. 4A, when a lithium-ion secondary battery is regarded as a closed circuit, lithium ions transfer and a current flows in the same direction. Further, in the lithium-ion secondary battery, an anode and a cathode change places in charge and discharge, and an oxidation reaction and a reduction reaction occur on the corresponding sides; hence, an electrode with a high redox potential is called a positive electrode and an electrode with a low redox potential is called a negative electrode in this specification. For this reason, in this specification, the positive electrode is referred to as a “positive electrode” and the negative electrode is referred to as a “negative electrode” in all the cases where charge is performed, discharge is performed, an inversion pulse current (also referred to as a reverse pulse current) is supplied, a discharging current is supplied, and a charging current is supplied.

The use of the terms “anode” and “cathode” related to an oxidation reaction and a reduction reaction might cause confusion because the anode and the cathode change places at the time of charging and discharging. Thus, the terms “anode” and “cathode” are not used in this specification. If the terms “anode” or “cathode” is used, it should be mentioned that the anode or the cathode is which of the one at the time of charging or the one at the time of discharging and corresponds to which of a positive electrode or a negative electrode.

In the lithium-ion secondary battery 501 (hereinafter referred to as the battery 501) illustrated in FIG. 3A and FIG. 4A, a positive electrode includes lithium iron phosphate (LiFePO₄) as a positive electrode active material, and a negative electrode includes graphite as a negative electrode active material.

As illustrated in FIG. 3A, when the battery 501 is charged, a reaction expressed by Formula (1) occurs in the positive electrode.

LiFePO₄→FePO₄+Li⁺+e⁻ (1)

In addition, a reaction expressed by Formula (2) occurs in the negative electrode.

C₆+Li⁺+e⁻→LiC₆ (2)

Thus, the overall reaction in charging the battery 501 is expressed by Formula (3).

LiFePO₄+C₆→FePO₄+LiC₆ (3)

The battery 501 is supposed to be charged when lithium ions are intercalated into graphite in the negative electrode; however, in the case where a lithium metal is deposited on the negative electrode because of any cause, a reaction expressed by Formula (4) occurs. That is, both a reaction of lithium intercalation into graphite and a lithium deposition reaction occur at the negative electrode.

Li⁺+e⁻→Li (4)

The equilibrium potentials of the positive electrode and the negative electrode are determined by a material and an equilibrium state of the material. The potential difference (voltage) between the electrodes varies depending on the equilibrium states of the materials of the positive electrode and the negative electrode.

FIG. 3B schematically shows changes in voltage over time during charge of the battery 501. As shown in FIG. 3B, in charging, as a reaction proceeds due to a current flow, the voltage between the positive electrode and the negative electrode increases and then does not change significantly.

As illustrated in FIG. 4A, when the battery 501 is discharged, a reaction expressed by Formula (5) occurs in the positive electrode.

FePO₄+Li⁺+e⁻→LiFePO₄ (5)

In addition, a reaction expressed by Formula (6) occurs in the negative electrode.

LiC₆→C₆+Li⁺+e⁻ (6)

Thus, the overall reaction in discharging the battery 501 is expressed by Formula (7).

FePO₄+LiC₆→LiFePO₄+C₆ (7)

In addition, in discharge performed after the lithium metal is deposited, a reaction expressed by Formula (8) occurs in the negative electrode. That is, both a reaction of lithium deintercalation from graphite and a lithium dissolution reaction occur at the negative electrode.

Li→Li⁺+e⁻ (8)

FIG. 4B schematically shows changes in voltage over time during charge of the battery 501. As shown in FIG. 4B, a discharging current flows without significant voltage changes, and then, the voltage between the electrodes sharply decreases. Thus, discharge is terminated.

### <Positive Electrode Potential and Negative Electrode Potential>

A positive electrode potential is an electrochemical equilibrium potential of a positive electrode active material, and a negative electrode potential is an electrochemical equilibrium potential of a negative electrode active material. For example, a potential at which a lithium metal is in electrochemical equilibrium in an electrolytic solution is 0 V (vs. Li/Li⁺). The same applies to other substances.

When the potential of a lithium metal is higher than 0 V (vs. Li/Li⁺), the lithium metal is dissolved and Li⁺ ions are released into an electrolytic solution, whereas when the potential of a lithium metal is lower than 0 V (vs. Li/Li⁺), Li⁺ ions in the electrolytic solution are deposited as lithium.

The electrochemical equilibrium potential of a lithium compound used for a positive electrode active material can be determined based on the potential of the lithium metal. For example, the electrochemical equilibrium potential of lithium iron phosphate (LiFePO₄) is approximately 3.5 V (vs. Li/Li⁺). The electrochemical equilibrium potential of graphite as a negative electrode active material is approximately 0.2 V (vs. Li/Li⁺).

Thus, the voltage of a lithium-ion secondary battery including lithium iron phosphate (LiFePO₄) as a positive electrode active material and graphite as a negative electrode active material (the electromotive force of an electrochemical cell) is 3.3 V, the difference between the electrochemical equilibrium potentials of the positive electrode active material and the negative electrode active material. The negative electrode potential which is as low as the potential of a lithium metal is a factor of the high cell voltage, which is a feature of the lithium-ion secondary battery.

Deposition of lithium on a surface of a negative electrode is a cause of a decrease in reliability and a reduction in the capacity of a lithium-ion secondary battery. However, the negative electrode potential (the electrochemical equilibrium potential of graphite) is approximately 0.2 V (vs. Li/Li⁺), which is close to the deposition potential of lithium of 0V (vs. Li/Li⁺); accordingly, lithium is easily deposited on a surface of a negative electrode. The factor of the high cell voltage, which is a feature of a lithium-ion secondary battery, is a significant cause of lithium deposition.

This will be described with reference to FIG. 5. FIG. 5 schematically illustrates the relation between the potential of a positive electrode and the potential of a negative electrode of a battery 501. The battery 501 includes lithium iron phosphate in the positive electrode and graphite in the negative electrode. Note that an arrow 505 denotes a charging voltage in FIG. 5.

The potential difference between the positive electrode including lithium iron phosphate and the negative electrode including graphite in electrochemical equilibrium is as follows: 3.5 V−0.2 V=3.3 V. At a charging voltage of 3.3 V, the reaction of Formula (1) and the reaction of Formula (5) equilibrate in the positive electrode and the reaction of Formula (2) and the reaction of Formula (6) equilibrate in the negative electrode; thus, a current does not flow.

For this reason, a charging voltage higher than 3.3 V is needs to be applied between the positive electrode and the negative electrode so that a charging current flows. The voltage for supplying the charging current is referred to as an overvoltage. For example, on the assumption that a series resistance component inside the battery 501 is ignored and all extra charging voltage is used in the electrode reactions of Formulae (1) and (2), as indicated by the arrow 505, the extra charging voltage is shared by the positive electrode and the negative electrode as an overvoltage (V1) to the positive electrode and an overvoltage (V2) to the negative electrode.

In order to obtain a higher current density per unit electrode area, a higher overvoltage is necessary. For example, when the battery is rapidly charged, a current density per unit surface area of an active material needs to be high, in which case a higher overvoltage is needed.

However, as the overvoltage is raised to increase the current density per unit surface area of the active material, the overvoltage V2 to the negative electrode increases; therefore, a potential V3 shown by the tip of the arrow 505 in FIG. 5 becomes lower than the potential of the lithium metal electrode. Then, the reaction of Formula (4) occurs. That is to say, lithium is deposited on the surface of the negative electrode.

In view of the above, the above technological idea makes it possible to obtain a lithium-ion secondary battery in which a lithium deposit (lithium metal) does not exist substantially on a surface of a negative electrode after charging.

In rapid charging, the potential of the negative electrode lowers and thus, lithium becomes more likely to be deposited. In a low-temperature environment, the resistance of a negative electrode increases, so that the potential of the negative electrode further lowers and lithium becomes more likely to be deposited accordingly. However, the above technological idea enables rapid charge of a metal-ion secondary battery and charge of a metal-ion secondary battery in a low-temperature environment.

That is to say, one embodiment of the present invention is an electrochemical device that includes a positive electrode, a negative electrode, and an electrolytic solution. The positive electrode includes a first layer including a positive electrode active material. The negative electrode includes a second layer including a negative electrode active material. The positive electrode active material contains a metal element that is released as a positive ion in charging. The metal element is not substantially deposited on a surface of the negative electrode.

An “inversion pulse current” is used as one mode of an “electrical stimulus” applied to an electrode in order to, for example, inhibit deposition of a metal element or dissolve a deposit of a metal element.

Another embodiment of the present invention is an electrochemical device that includes a positive electrode, a negative electrode, and an electrolytic solution. The positive electrode includes a first layer including a positive electrode active material. The negative electrode includes a second layer including a negative electrode active material. A first current that flows between the positive electrode and the negative electrode in a first direction and an inversion pulse current that flows between the positive electrode and the negative electrode in the reverse direction of the first direction are alternately supplied to the positive electrode or the negative electrode repeatedly, whereby charge or discharge is performed. A time for one inversion pulse current supply is shorter than a time for one first current supply.

One inversion pulse current supply time is longer than or equal to one hundredths of one first current supply time and shorter than or equal to one third of one first current supply time. Specifically, one inversion pulse current supply time can be longer than or equal to 0.1 seconds and shorter than or equal to 3 minutes, and is typically longer than or equal to 3 seconds and shorter than or equal to 30 seconds.

The “inversion pulse current” refers to a signal for supplying a current between a positive electrode and a negative electrode in the reverse direction of a current that flows between the positive electrode and the negative electrode when a battery is charged or discharged (the current is a charging current when a battery is charged, and is a discharging current when the battery is discharged). The time for one inversion pulse current supply to the electrode should be shorter than the time during which the charging current or the discharging current flows after the previous supply of the inversion pulse current and is preferably sufficiently short. The expression “pulse” of the “inversion pulse current” covers not only momentary the flow of a current in the reverse direction of a charging current or a discharging current when a battery is charged or discharged but also the temporary flow of a current in the reverse direction of a charging current or a discharging current for a period of time that cannot be perceived as momentary by intuition (for example, for longer than or equal to 1 second).

### <Dross Formation and Dissolution Mechanism 1>

First, a mechanism of dross formation on an electrode surface and a mechanism of dross dissolution will be described below with reference to FIGS. 6A to 6F.

Note that the term “dross” refers to a reaction product generated on an electrode surface and includes a depleted substance and a deposit in its category; an example of a compound is whiskers. Dross is typically a deposit of a metal ion, and is lithium in the case of a lithium-ion secondary battery. Dross may include a compound.

The term “depleted substance” refers to a substance generated in such a manner that part of a component (e.g., an electrode or an electrolytic solution) alters and degrades. The term “deposit” refers to a substance generated in such a manner that a crystal or a solid component is separated from a liquid substance, and a deposit can have a film shape, a particle shape, a whisker shape, or the like. The term “whisker” means a crystal grown outward from a crystal surface so as to have a whisker shape.

FIGS. 6A to 6F are schematic cross-sectional views illustrating part of a battery including at least a positive electrode, a negative electrode, and an electrolytic solution. The positive electrode includes at least a layer including a positive electrode active material (hereinafter referred to as a positive electrode active material layer), and a negative electrode includes at least a layer including a negative electrode active material (hereinafter referred to as a negative electrode active material layer).

Although FIGS. 6A to 6F illustrate only one electrode 101 and an electrolytic solution 103 the vicinity of the electrode 101 for the sake of simplicity, the electrode 101 and the electrolytic solution 103 actually correspond to a positive electrode 12 or a negative electrode 14 and an electrolytic solution 13 of a battery 10 in FIG. 1B, respectively. The electrode 101 is either a positive electrode or a negative electrode; however, descriptions will be made on the assumption that the electrode 101 is a negative electrode.

In charging the battery, a current Ia (charging current) flows from the right side to the left side of FIG. 6A. An inversion pulse current Iinv flows in the reverse direction of the current Ia flow (the direction from the left side to the right side of FIG. 6A). Accordingly, provided that the direction of the inversion pulse current Iinv flow is the positive direction of current, the current value of the inversion pulse current is a positive value (Iinv), and the current value of the charging current is a negative value (−Ia).

FIGS. 6A to 6C are schematic cross-sectional views sequentially illustrating the states of the electrode 101 of the battery, specifically, the states of reaction products 102a, 102b, and 102c abnormally grown on a surface of the negative electrode 101 in charging.

FIG. 6A illustrates the state where a current is supplied between the negative electrode 101 and a positive electrode (not illustrated) during a period T1 and the reaction products 102a are deposited on the negative electrode 101 so that the negative electrode 101 is dotted with the reaction products 102a.

FIG. 6B illustrates the state where a current is supplied between the negative electrode and the positive electrode inside the battery during a period T2 (T2 is longer than T1). Projections of the reaction product 102b are abnormally grown from the positions where they are deposited and the reaction product 102b is deposited on the entire surface of the negative electrode 101.

FIG. 6C illustrates the state where a current is supplied during a period T3 longer than the period T2. Projections of the reaction product 102c in FIG. 6C are grown to be longer than the projections of the reaction product 102b in FIG. 6B in the direction perpendicular to the negative electrode 101. A thickness d2 of the projection of the reaction product 102c is larger than or equal to a thickness d1 of the projection of the reaction product 102b illustrated in FIG. 6B.

Dross is not uniformly deposited on the entire surface of the electrode as a current supply time passes. Once dross is deposited, dross is more likely to be deposited on the position where the dross has been deposited than on the other positions, and a larger amount of dross is deposited on the position and grown to be a large lump. The region where a large amount of dross has been deposited has a higher conductivity than the other region. For this reason, a current is likely to concentrate at the region where the large amount of dross has been deposited, and the dross is grown around the region faster than in the other region. Accordingly, a projection and a depression are formed by the region where a large amount of dross is deposited and the region where a small amount of dross is deposited, and the projection and the depression become larger as time goes by as illustrated in FIG. 6C. Finally, the large projection and depression cause severe deterioration of the battery.

After the state in FIG. 6C, a signal with which a current flows in the reverse direction of the current with which the reaction product is formed, an inversion pulse current here, is supplied to dissolve the reaction product. FIG. 6D illustrates the state at the time immediately after the inversion pulse current is supplied. As shown by arrows in FIG. 6D, a reaction product 102d is dissolved from its growing point. This is because when the inversion pulse current is supplied, the potential gradient around the growing point of the reaction product 102d becomes steep, so that the growing point is likely to be preferentially dissolved. Note that the growing point is at least a part of a surface of the reaction product 102d, for example, a surface of a tip of the reaction product 102d.

The inversion pulse current is supplied in the state where the projection and depression due to non-uniform deposition of dross are formed, whereby a current concentrates at the projection and the dross is dissolved. The dross dissolution means that dross in a region in the electrode surface where a large amount of dross is deposited is dissolved to reduce the area of the region where a large amount of dross is deposited, preferably means that the electrode surface is restored to the state at the time before dross is deposited on the electrode surface. As well as restoration of the electrode surface to the state at the time before dross is deposited on the electrode surface, even reduction of dross can provide a significant effect.

FIG. 6E illustrates a state in the middle of the dissolution of the reaction product; the reaction product 102d is dissolved from its growing point to be the reaction product 102e smaller than the reaction product 102d.

Then, the inversion pulse current is supplied from at least one of the positive electrode and the negative electrode so that it flows in the reverse direction of the current with which the reaction product is formed.

The inversion pulse current is supplied one or more times, whereby, ideally, the surface of the negative electrode 101 can be restored to the state at the time before the reaction product is deposited on the surface of the negative electrode 101 as illustrated in FIG. 6F.

Supply of the inversion pulse current does not necessarily completely restore the surface of the negative electrode 101 to the initial state, but can at least inhibit aggregation (increase in density) of the reaction product. Accordingly, the speed of deterioration of the battery can be slowed down.

Supplying more than once the inversion pulse current with which a current flows between the positive electrode and the negative electrode in the reverse direction of the current with which the reaction product is formed in a period during which a current is supplied between the positive electrode and the negative electrode in the direction such that the reaction product is formed is also one of technological ideas of the present invention. The inversion pulse current is supplied to the reaction product, whereby the reaction product is dissolved from its growing point into the electrolytic solution. Two or more times of supply of the inversion pulse current enables inhibition of growth of the reaction product.

According to one embodiment of the present invention, in the case of supplying an inversion pulse current in charging a battery, one inversion pulse current supply time is shorter than one charging current supply time, that is, a time during which a reaction product is formed. Also in the case of discharging the battery, one inversion pulse current supply time is shorter than one discharging current supply time.

In the case where the reaction product is dissolved into the electrolytic solution at high speed or the amount of deposited reaction product is small, the state in FIG. 6D can be changed into the state in FIG. 6F even with an extremely short time of inversion pulse current supply.

Depending on the condition (e.g., pulse width or timing) under which the inversion pulse current is supplied, even with only one-time inversion pulse current supply, the state in FIG. 6D can be changed into the state in FIG. 6F.

Although the negative electrode is taken as an example in FIGS. 6A to 6F, the above description can also apply to the positive electrode without no particular limitation and similar effect can be obtained. For example, in the case where a reaction product such as a decomposition product of an electrolytic solution is deposited on a positive electrode in charging, the reaction product can be dissolved by supplying an inversion pulse current.

Although descriptions are made taking charge as an example in FIGS. 6A to 6F, also in the case of discharge, reaction products deposited on the negative electrode and the positive electrode can be dissolved by the inversion pulse current.

Further, in charging the battery, the inversion pulse current is supplied more than once to at least one of the positive electrode and the negative electrode so that a current flows in the reverse direction of the current with which a reaction product is formed. Further, also in discharging the battery, the inversion pulse current is supplied more than once to at least one of the positive electrode and the negative electrode so that a current flows in the reverse direction of the current with which a reaction product is formed. The supply of the inversion pulse current can inhibit deterioration of the battery or reduce the degree of deterioration of the battery.

This embodiment is not limited to the mechanism illustrated in FIGS. 6A to 6F. Hereinafter, another example of a mechanism of dross formation and dissolution will be described.

### <Dross Formation and Dissolution Mechanism 2>

FIGS. 7A to 7F illustrate a mechanism partly different from that in FIGS. 6A to 6F in the process of generation of a reaction product; the reaction product is deposited on an entire surface of an electrode and is partly grown abnormally.

FIGS. 7A to 7C are schematic cross-sectional views sequentially illustrating the states of an electrode 201, specifically, the states of reaction products 202a, 202b, and 202c abnormally grown on a surface of a negative electrode in charging, as in FIGS. 6A to 6C.

FIG. 7A illustrates the state where a current is supplied between the negative electrode and a positive electrode (not illustrated) inside a battery during the period T1, and the reaction products 202a are deposited on the entire surface of the electrode 201 serving as the negative electrode and partly grown abnormally. Examples of a material of the electrode 201 on which the reaction product 202a is deposited are graphite, a combination of graphite and graphene oxide, and titanium oxide.

FIG. 7B illustrates the state of the reaction product 202b grown when a current is supplied between the negative electrode and the positive electrode during the period T2 (T2 is longer than T1). FIG. 7C illustrates the state of the reaction product 202c grown when a current is supplied during the period T3 longer than the period T2. Also in this example, a thickness d12 of a projection of the reaction product 202c is larger than or equal to a thickness d11 of a projection of the reaction product 202b.

After the state in FIG. 7C, a signal with which a current flows in the reverse direction of the current with which the reaction product is formed (inversion pulse current) is supplied to dissolve the reaction product. FIG. 7D illustrates the state at the time immediately after the inversion pulse current is supplied. As shown by arrows in FIG. 7D, a reaction product 202d is dissolved from its growing point.

FIG. 7E illustrates a stage in the middle of the dissolution of the reaction product; the reaction product 202d is dissolved from its growing point to be the reaction product 202e smaller than the reaction product 202d.

In this manner, one embodiment of the present invention can be applied regardless of the process of generation of the reaction product and the mechanism thereof. A signal with which a current flows in the reverse direction of the current with which the reaction product is formed is supplied one or more times, whereby, ideally, the surface of the electrode 201 can be restored to the initial state at the time before the reaction product is deposited on the surface of the negative electrode 201 as illustrated in FIG. 7F.

### <Dross Formation and Dissolution Mechanism 3>

Unlike FIGS. 6A to 6F, FIGS. 8A to 8F are an example where a protective film is formed on an electrode surface and illustrate a state where a reaction product is deposited in a region not covered with the protective film and is abnormally grown.

FIGS. 8A to 8C are schematic cross-sectional views sequentially illustrating the states of reaction products 302a, 302b, and 302c abnormally grown and formed in a region of a surface of an electrode 301 (typically, a negative electrode) that is not covered with a protective film 304. For the protective film 304, a single layer of a silicon oxide film, a niobium oxide film, or an aluminum oxide film or a stack including any of the films is used.

FIG. 8A illustrates the state where a current is supplied between the negative electrode and a positive electrode (not illustrated) inside a battery during the period T1, and the reaction products 302a are deposited on exposed portions of the electrode 301 serving as the negative electrode and are grown abnormally.

FIG. 8B illustrates the state of the reaction product 302b grown when a current is supplied between the negative electrode and the positive electrode during the period T2 (T2 is longer than T1). FIG. 8C illustrates the state of the reaction product 302c grown when a current is supplied during the period T3 longer than the period T2.

After the state in FIG. 8C, a signal with which a current flows in the reverse direction of the current with which the reaction product is formed (inversion pulse current) is supplied to dissolve the reaction product. FIG. 8D illustrates the state at the time immediately after the inversion pulse current is supplied. As shown by arrows in FIG. 8D, a reaction product 302d is dissolved from its growing point.

FIG. 8E illustrates the state where the reaction product is in the middle of the dissolution; the reaction product 302d is dissolved from its growing point to be the reaction product 302e smaller than the reaction product 302d. The utilization of the mechanism illustrated in FIGS. 8A to 8F enables fabrication of a novel electrochemical device based on an extremely novel principle.

The technological ideas disclosed in this specification are mere examples, and thus modifications and variations thereof can be regarded as being in the scope of the present invention.

According to one embodiment of the present invention, an inversion pulse current, which is a signal with which a current flows between a positive electrode and a negative electrode in the reverse direction of a current with which a reaction product is formed, is supplied between the positive electrode and the negative electrode, whereby the reaction product (dross) deposited on a surface of the electrode can be dissolved. Thus, according to this embodiment, the electrode surface can be restored to the initial state even when it is changed or the state of the electrode surface can be prevented from being changed, so that a battery that will not deteriorate in principle can be obtained. That is to say, since a maintenance-free battery can be fabricated, a device provided with the battery can be used for a long time.

With the use of the technological ideas of the present invention of utilizing the mechanism of formation of a reaction product and the mechanism of dissolution of the reaction product, even when part of an electrochemical device deteriorates, the degree of deterioration can be reduced or ideally, the electrochemical device can be restored to the initial state.

### BRIEF DESCRIPTION OF DRAWINGS

In the accompanying drawings:

FIGS. 1A to 1C are schematic diagrams illustrating an example of a method for supplying an inversion pulse current;

FIG. 2 is a schematic diagram illustrating an example of an influence of an inversion pulse current;

FIGS. 3A and 3B are schematic diagrams illustrating the principle of charge of a lithium-ion secondary battery;

FIGS. 4A and 4B are schematic diagrams illustrating the principle of discharge of a lithium-ion secondary battery;

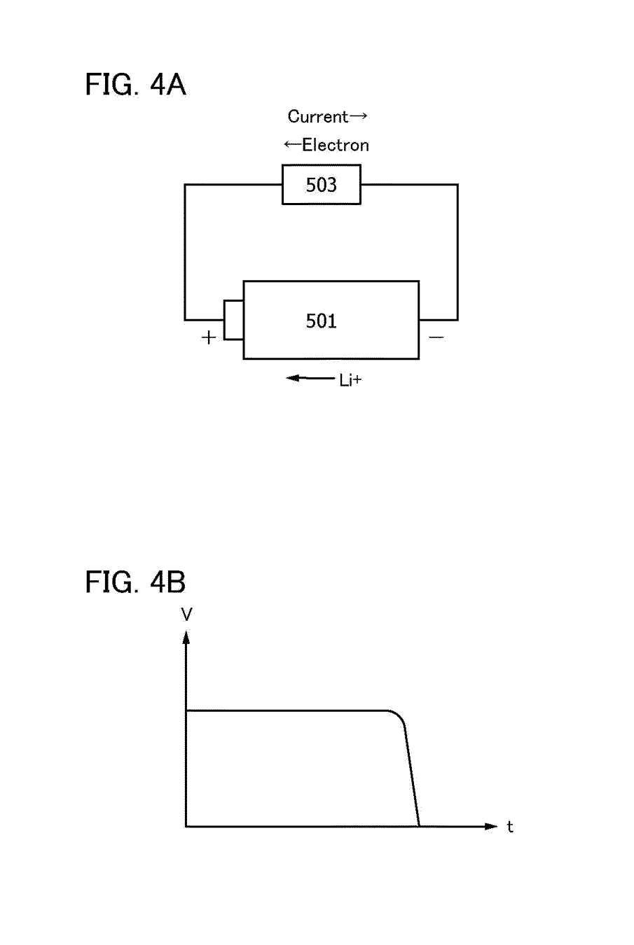

FIG. 5 is a schematic diagram illustrating the potentials of electrodes of a lithium-ion secondary battery;

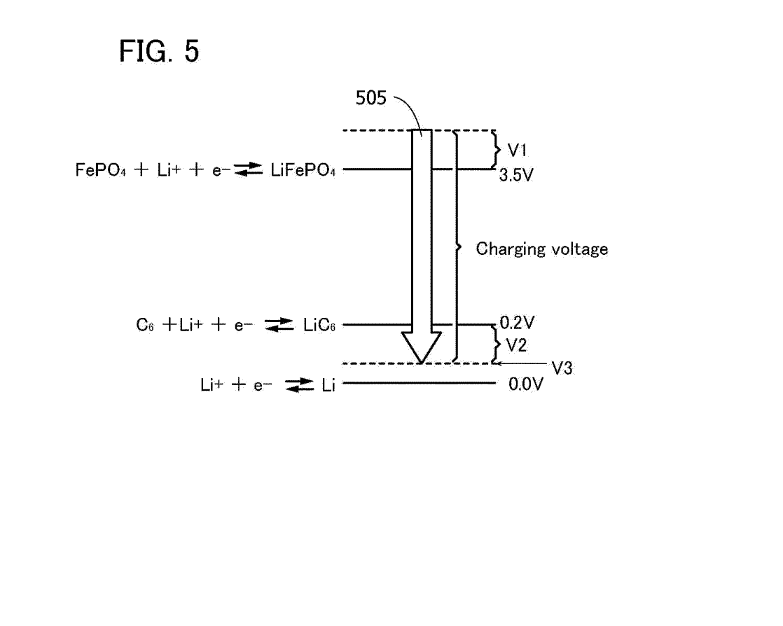

FIGS. 6A to 6C are schematic cross-sectional views illustrating an example of a mechanism of formation of a reaction product on an electrode surface, and FIGS. 6D to 6F are schematic cross-sectional views illustrating an example of a mechanism of dissolution of the reaction product on the electrode surface;

FIGS. 7A to 7C are schematic cross-sectional views illustrating an example of a mechanism of formation of a reaction product on an electrode surface, and FIGS. 7D to 7F are schematic cross-sectional views illustrating an example of a mechanism of dissolution of the reaction product on the electrode surface;

FIGS. 8A to 8C are schematic cross-sectional views illustrating an example of a mechanism of formation of a reaction product on an electrode surface, and FIGS. 8D to 8F are schematic cross-sectional views illustrating an example of a mechanism of dissolution of the reaction product on the electrode surface;

FIGS. 9A to 9C are schematic diagrams illustrating a structural example of an electrochemical device;

FIGS. 10A and 10B illustrate structural examples of electrochemical devices;

FIGS. 11A and 11B illustrate a structural example of an electrochemical device;

FIGS. 12A to 12C illustrate a structural example of an electrochemical device;

FIGS. 13A to 13C illustrate a structural example of an electrical device provided with an electrochemical device;

FIGS. 14A and 14B is a structural example of an electrical device;

FIGS. 15A and 15B each illustrate a structural example of an electrical device;

FIGS. 16A and 16B are graphs showing change in charging current and inversion pulse current supplied to a cell for evaluation and change in voltage of the cell for evaluation in charging;

FIG. 17A is a graph showing change in voltage of a cell for evaluation with respect to charge capacity in the case where an inversion pulse current is not supplied, and FIG. 17B is a graph showing change in voltage of a cell for evaluation with respect to charge capacity in the case where an inversion pulse current is supplied for 1 second for one supply period;

FIG. 18A is a graph showing change in voltage of a cell for evaluation with respect to charge capacity in the case where an inversion pulse current is supplied for 5 seconds for one supply period, and FIG. 18B is a graph showing change in voltage of a cell for evaluation with respect to charge capacity in the case where an inversion pulse current is supplied for 10 seconds for one supply period;

FIG. 19 is a schematic diagram illustrating a structure of a cell for evaluation and methods for charging and discharging the cell for evaluation;

FIGS. 20A and 20B are graphs showing changes over time in current supplied to a cell for evaluation;

FIGS. 21A and 21B are graphs showing changes over time in voltage of a cell for evaluation, and FIG. 21C is a graph showing changes in voltage of the cell for evaluation with respect to charge capacity;

FIGS. 22A and 22B are graphs showing changes over time of current supplied to a cell for evaluation;

FIGS. 23A and 23B are graphs showing changes over time in voltage of a cell for evaluation, and FIG. 23C is a graph showing changes in voltage of the cell for evaluation with respect to charge capacity;

FIG. 24A is a scanning electron microscope (SEM) secondary electron image of a surface of a negative electrode of a cell for evaluation, and FIG. 24B is a SEM secondary electron image of a surface of a negative electrode of a comparative cell; and

FIG. 25A is a SEM secondary electron image of natural graphite with a spherical shape, and FIG. 25B is a SEM secondary electron image of flaky graphite.

### BEST MODE FOR CARRYING OUT THE INVENTION

Hereinafter, embodiments and examples of the present invention will be described in detail with reference to the accompanying drawings. However, the present invention is not limited to the following descriptions and it is easily understood by those skilled in the art that the mode and details can be variously changed without departing from the spirit and scope of the present invention. Accordingly, the present invention should not be construed as being limited to the descriptions of the embodiments and examples below.

Note that in the drawings used for the descriptions of the embodiments and examples of the invention, the same portions or portions having similar functions are denoted by the common reference numerals, and repeated descriptions thereof are omitted in some cases.

### Embodiment 1

In this embodiment, a method for supplying an inversion pulse current will be described.

### <Example of Method for Supplying Inversion Pulse Current>

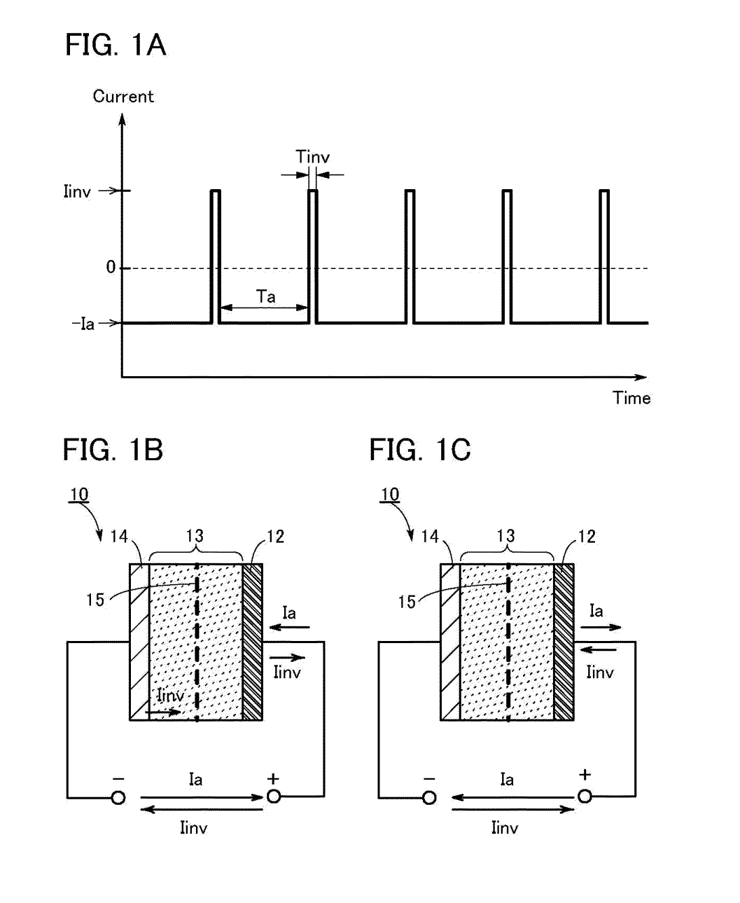

An inversion pulse current will be described with reference to FIGS. 1A to 1C. FIG. 1A is a graph schematically showing changes over time of current supplied to a positive electrode or a negative electrode of the battery 10 in charging or discharging the battery 10 (FIG. 1B). A current Ia corresponds to a charging current when the battery 10 is charged, and corresponds to a discharging current when the battery 10 is discharged. In this embodiment, Ia is a constant current for simplicity; however, the amount of Ia may be varied depending on the condition of the battery 10. Although an inversion pulse current Iinv is also a constant current like Ia, the amount of inversion pulse current Iinv may be varied depending on the condition of the battery 10. In addition, the direction in which the inversion pulse current Iinv flows is defined as the positive direction of current in some cases. In such a case, since the inversion pulse current Iinv at the time of charging and the inversion pulse current Iinv at the time of discharging flow in opposite directions, the directions of the reference current at the time of charging and the reference current at the time of discharging are opposite to each other. Therefore, in charging and in discharging, the inversion pulse current values are positive values (Iinv), and the charging current value or the discharging current value is a negative value (−Ia).

For easy understanding of this embodiment, charge will be described first. FIG. 1B illustrates the charging current Ia and the inversion pulse current Iinv supplied to the battery 10 in charging. Provided that the charging current Ia and the inversion pulse current Iinv flow in opposite directions, the current value of the inversion pulse current is a positive value (Iinv), and the current value of the charging current is also a positive value (Ia).

In the battery 10, a reference numeral 12 denotes a positive electrode, 13 denotes an electrolytic solution, 14 denotes a negative electrode, and 15 denotes a separator.

As illustrated in FIG. 1B, in charging the battery 10, the charging current Ia flows in the direction from the negative electrode 14 to the positive electrode 12 outside the battery 10, and flows in the direction from the positive electrode 12 to the negative electrode 14 inside the battery 10; thus, the inversion pulse current Iinv is supplied to the negative electrode 14 or the positive electrode 12 so that the charging current Ia flows in the direction from the positive electrode 12 to the negative electrode 14 outside the battery 10, and flows in the direction from the negative electrode 14 to the positive electrode 12 inside the battery 10. In the case of FIG. 1B, in charging, the current Ia is supplied to the positive electrode 12 from outside of the battery 10, and the inversion pulse current Iinv is supplied to outside of the battery 10 from the positive electrode 12.

As illustrated in FIG. 1C, in discharging the battery 10, the discharging current Ia flows in the direction from the positive electrode 12 to the negative electrode 14 outside the battery 10, and flows in the direction from the negative electrode 14 to the positive electrode 12 inside the battery 10; thus, the inversion pulse current Iinv is supplied to the negative electrode 14 or the positive electrode 12 to flow in the direction from the negative electrode 14 to the positive electrode 12 outside the battery 10, and to flow in the direction from the positive electrode 12 to the negative electrode 14 inside the battery 10. In the case of FIG. 1C, in discharging, the current Ia is supplied to the negative electrode 14 from outside of the battery 10, and the inversion pulse current Iinv is supplied to outside of the battery 10 from the negative electrode 14.

As for supply of current, a current can be supplied to the battery 10 from a supply source for supplying power such as a current or a voltage that exists outside the battery 10, or a current can be supplied to a load including a passive element such as a resistor or a capacitor and an active element such as a transistor or a diode from the battery 10 serving as a supply source. The case where the battery 10 is a power supply source and supplies a current to such a load corresponds to the case of discharging the battery 10. Thus, the inversion pulse current Iinv at the time of charging the battery 10 corresponds to a current in the case of discharging the battery 10, and the inversion pulse current Iinv at the time of discharging the battery 10 corresponds to a current in the case of charging the battery 10.

As shown in FIG. 1A, in charging (discharging), the inversion pulse current Iinv is supplied to the positive electrode 12 or the negative electrode 14 repeatedly more than once in a period during which the charging (discharging) current Ia is supplied to the positive electrode 12 or the negative electrode 14. A time for one inversion pulse current supply Tinv is set to shorter than a time for current Ia supply Ta. The time Tinv is set in consideration of a charge rate, a discharge rate, or the like.

The time for one inversion pulse current supply Tinv should be, for example, longer than or equal to one hundreds of the time for one current Ia supply Ta and shorter than or equal to one third of the time Ta. Specifically, given that Tinv is shorter than Ta, the time Tinv is preferably longer than or equal to 0.1 second and shorter than or equal to 3 minutes, typically longer than or equal to 3 seconds and shorter than or equal to 30 seconds.

FIG. 1A shows an example where the value (absolute value) of the inversion pulse current Iinv is greater than the value (absolute value) of the current Ia. In this embodiment, the value (absolute value) of the inversion pulse current Iinv can be less than or equal to the value of the current Ia as long as the inversion pulse current flows between the positive electrode and the negative electrode more than once in a period during which the current Ia is supplied.

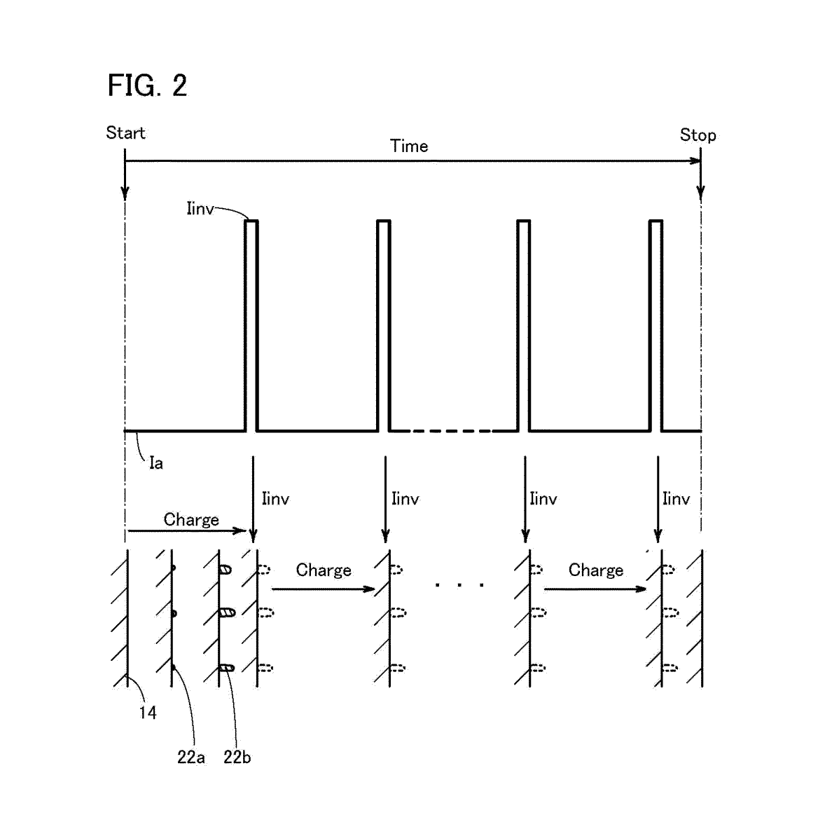

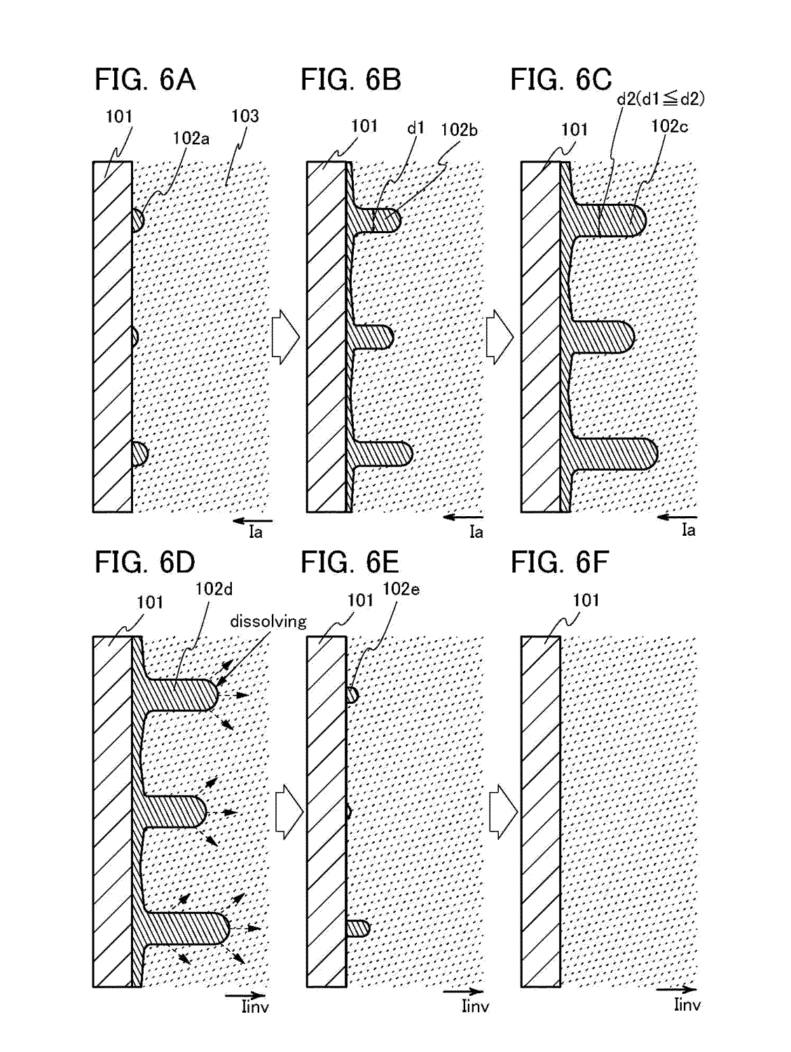

Effects of preventing or inhibiting deterioration of a battery by supplying an inversion pulse current will be described with reference to FIG. 2. FIG. 2 schematically illustrates waveforms of current (charging current Ia and inversion pulse current Iinv) supplied from the positive electrode 12 in charge operation, deposition of a reaction product on a surface of the negative electrode 14, and process of dissolution. Note that FIGS. 6A to 6F can be referred to for the mechanism of formation and dissolution of a reaction product in FIG. 2.

A charging method is a constant current charging. First, when charge is started, a reaction product is not deposited on the surface of the negative electrode 14, that is, the battery 10 is in the initial state just after shipment. When the charging current Ia is kept being supplied to the battery 10, a reaction product 22a is deposited on the surface of the negative electrode 14. The reaction product 22a is a deposit of a metal such as lithium, for example. As time passes, the reaction product 22a is grown to be the reaction product 22b. Thus, by supplying the inversion pulse current Iinv, the surface of the negative electrode 14 is restored to the state where the reaction product 22b does not exist on the surface of the negative electrode 14. The reaction product 22b is dissolved to be ions in the electrolytic solution 13, for example.

Then, the supply of the inversion pulse current Iinv is stopped and the charging current Ia is supplied. When the charging current Ia is supplied, the reaction product 22b is deposited on the surface of the negative electrode 14 again; however, the reaction product 22b can be dissolved every time the inversion pulse current Iinv is supplied.

Thus, it is possible that the reaction product 22b does not exist on the surface of the negative electrode 14 at the time of termination of charge, as in starting charge (at the time of shipment). That is, it is preferable that the surface of the negative electrode 14 be restored to the state where the reaction product 22b does not exist on the surface of the negative electrode 14 by supplying the inversion pulse current Iinv once. Such charge can be performed when the amount of inversion pulse current Iinv, a time for supplying the inversion pulse current Iinv, and an interval during which the inversion pulse current is supplied (corresponding to the time Ta when the charging current Ia is supplied) are adjusted.

For example, as the time Ta when the charging current Ia is supplied increases, the amount of the reaction product increases and thus it becomes more difficult to dissolve, and the reaction product alters or is solidified (increased in density) more significantly and thus it becomes more difficult to dissolve. Therefore, in order that the surfaces of the negative electrode 14 and the positive electrode 12 be maintained favorable, the amount of inversion pulse current Iinv, the time Tinv, and the time Ta are set as described above.

In the example of FIG. 2, the state of charge is monitored; thus, charge is terminated when the charging current Ia is supplied. The last supply of the charging current Ia is preferably performed for a short time so that the reaction product is not grown on the surface of the negative electrode 14. Further, the current supplied at the end of the charge may be controlled to be the inversion pulse current Iinv. In the example of FIG. 2, the times Tinv are equal to each other and the times Ta are equal to each other; however, the lengths thereof are not limited thereto.

### <Structural Example of Battery>

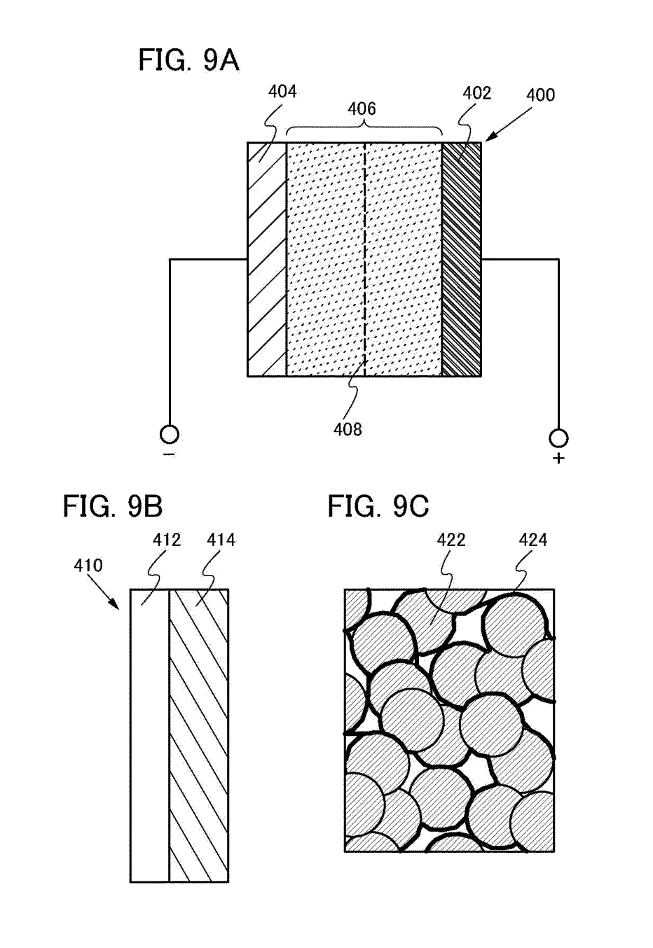

A structural example of a battery will be described below with reference to FIGS. 9A to 9C.

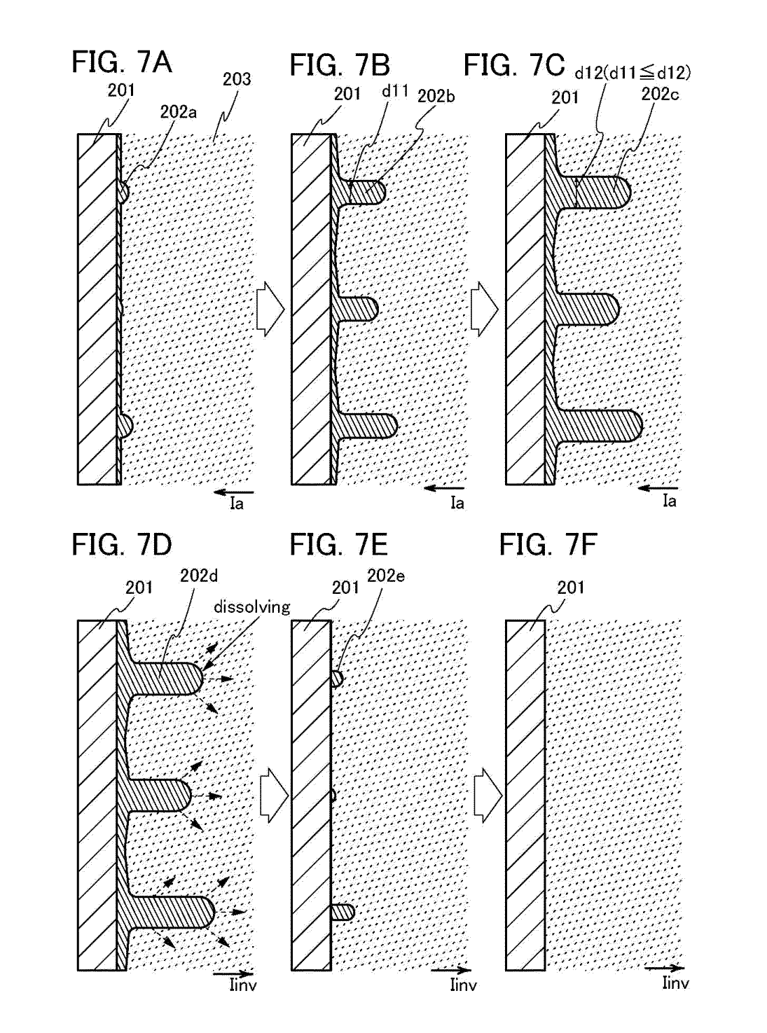

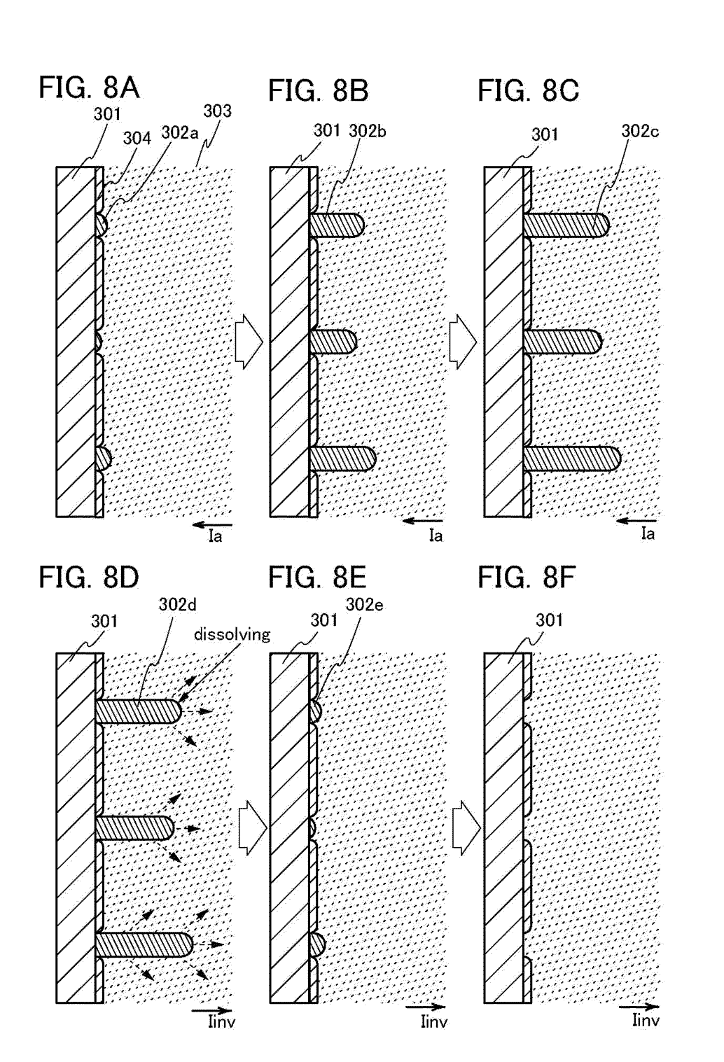

FIG. 9A is a cross-sectional view of a battery 400. A positive electrode 402 includes at least a positive electrode current collector and a positive electrode active material layer in contact with the positive electrode current collector. A negative electrode 404 includes at least a negative electrode current collector and a negative electrode active material layer in contact with the negative electrode current collector. The positive electrode active material layer faces the negative electrode active material layer, and an electrolytic solution 406 and a separator 408 are provided between the positive electrode active material layer and the negative electrode active material layer. The negative electrode 404 corresponds to the electrode 101 in FIGS. 6A to 6F, the electrode 201 in FIGS. 7A to 7F, and the electrode 301 in FIGS. 8A to 8F.

Examples of batteries that can be used as the battery 400 include but are not limited to secondary batteries such as a lithium-ion secondary battery, a lead storage battery, a lithium-ion polymer secondary battery, a nickel-hydrogen storage battery, a nickel-cadmium storage battery, a nickel-iron storage battery, a nickel-zinc storage battery, and a silver oxide-zinc storage battery; flow batteries such as a redox flow battery, a zinc-chlorine battery, and a zinc-bromine battery; mechanically rechargeable batteries such as an aluminum-air battery, a zinc-air battery, and an iron-air battery; and high-operating-temperature secondary batteries such as a sodium-sulfur battery and a lithium-iron sulfide battery.

Note that this embodiment can be applied not only to batteries but also to devices that utilize an electrochemical reaction (electrochemical devices); for example, this embodiment can be applied to metal-ion capacitors such as a lithium-ion capacitor.

FIG. 9B is a cross-sectional view of a battery electrode 410 (corresponding to the positive electrode 402 and the negative electrode 404 in FIG. 9A). As illustrated in FIG. 9B, in the electrode 410, an active material layer 414 is provided over the current collector 412. The active material layer 414 is formed over only one surface of the current collector 412 in FIG. 9B; however, active material layers 414 may be formed so that the current collector 412 is sandwiched therebetween. The active material layer 414 does not necessarily need to be formed over the entire surface of the current collector 412 and a region that is not coated, such as a region for connection to an external terminal, is provided as appropriate.

### <Current Collector>

There is no particular limitation on the current collector 412 as long as it has high conductivity without causing a chemical change in the battery 400. Examples of the current collector material are metals such as gold, platinum, zinc, iron, nickel, copper, aluminum, titanium, or tantalum, an alloy thereof, stainless steel, sintered carbon, and a metal element that forms silicide by reacting with silicon. Examples of the metal element that forms silicide by reacting with silicon are zirconium, titanium, hafnium, vanadium, niobium, tantalum, chromium, molybdenum, tungsten, cobalt, and nickel. The current collector 412 can have any of a variety of shapes such as a foil-like shape, a plate-like shape (sheet-like shape), a net-like shape, a cylindrical shape, a coil shape, a punching-metal shape, and an expanded-metal shape. The current collector 412 preferably has a thickness of greater than or equal to 10 μm and less than or equal to 30 μm.

### <Active Material Layer>

The active material layer 414 includes at least active materials. The active material layer 414 may further include a binder for increasing adhesion of the active materials, a conductive additive for increasing the conductivity of the active material layer 414, and the like in addition to the active materials.

### <Positive Electrode Active Material>

In the case of using the battery electrode 410 as the positive electrode 402, a material into and from which lithium ions can be inserted and extracted can be used for active materials (hereinafter referred to as positive electrode active materials) included in the active material layer 414. Examples of such positive electrode active materials are a compound with an olivine crystal structure, a compound with a layered rock-salt crystal structure, and a compound with a spinel crystal structure. Specifically, a compound such as LiFeO₂, LiCoO₂, LiNiO₂, LiMn₂O₄, V₂O₅, Cr₂O₅, or MnO₂ can be used for the positive electrode active materials.

As an olivine-type compound, a lithium-containing complex phosphate is given. Typical examples of a lithium-containing complex phosphate (LiMPO₄ (general formula) (M is one or more of Fe(II), Mn(II), Co(II), and Ni(II))) are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly has properties necessary for the positive electrode active material, such as safety, stability, high capacity density, high potential, and the existence of lithium ions which can be extracted in initial oxidation (charge).

Examples of a lithium-containing compound with a layered rock-salt crystal structure are lithium cobalt oxide (LiCoO₂), LiNiO₂, LiMnO₂, Li₂MnO₃, NiCo-containing composite oxide (general formula: LiNiₓCo₁₋ₓO₂ (0<x<1)) such as LiNi_{0.8}Co_{0.2}O₂, NiMn-containing composite oxide (general formula: LiNiₓMn₁₋ₓO₂(0<x<1)) such as LiNi_{0.5}Mn_{0.5}O₂, NiMnCo-containing composite oxide (also referred to as NMC) (general formula: LiNiₓMn_{y}Co_{1-x-y}O₂ (x>0, y>0, x+y<1)) such as LiNi_{1/3}Mn_{1/3}Co_{1/3}O₂, Li(Ni_{0.8}Co_{0.15}Al_{0.05})O₂, and Li₂MnO₃—LiMO₂ (M=Co, Ni, or Mn).

Examples of a lithium-containing compound with a spinel crystal structure are LiMn₂O₄, Li₁₋ₓMn₂₋ₓO₄, Li(MnAl)₂O₄, and LiMm₅Ni_{0.5}O₄.

In the case of using a compound with a spinel crystal structure which contains lithium and manganese, such as LiMn₂O₄, for the positive electrode active material, it is preferable to add a small amount of lithium nickel oxide (LiNiO₂ or LiNi₁₋ₓMO₂ (M=Co, Al, or the like)) to the compound because advantages such as minimization of the elution of manganese and the decomposition of an electrolytic solution can be obtained.

Alternatively, a lithium-containing compound such as Li₍₂₋ⱼ₎MSiO₄ (general formula) (M is one or more of Fe(II), Mn(II), Co(II), and Ni(II), 0≦j≦2) can be used for the positive electrode active material. Typical examples of Li₍₂₋ⱼ₎MSiO₄ (general formula) are lithium compounds such as Li₍₂₋ⱼ₎FeSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Still alternatively, a nasicon compound expressed by AₓM₂(XO₄)₃ (general formula) (A=Li, Na, or Mg, M=Fe, Mn, Ti, V, Nb, or Al, X═S, P, Mo, W, As, or Si) can be used for the positive electrode active material. Examples of the nasicon compound are Fe₂(MnO₄)₃, Fe₂(SO₄)₃, and Li₃Fe₂(PO₄)₃. Further alternatively, a compound expressed by Li₂MPO₄F, Li₂MP₂O₇, or Li₅MO₄ (general formula) (M=Fe or Mn), a perovskite fluoride such as NaF₃ or FeF₃, a metal chalcogenide (a sulfide, a selenide, or a telluride) such as TiS₂ or MoS₂, a lithium-containing compound with an inverse spinel crystal structure such as LiMVO₄, a vanadium oxide (V₂O₅, V₆O₁₃, LiV₃O₈, or the like), a manganese oxide, an organic sulfur, or the like can be used as the positive electrode active material.

In the case where carrier ions are alkali metal ions other than lithium ions, or alkaline-earth metal ions, the following may be used as the positive electrode active material: a compound which is obtained by substituting an alkali metal (e.g., sodium or potassium) or an alkaline-earth metal (e.g., calcium, strontium, barium, beryllium, or magnesium), for lithium in the lithium-containing compound.

### <Negative Electrode Active Material>

When the battery electrode 410 is used as the negative electrode 404 of the battery 400, the active material layer 414 includes a negative electrode active material. A material with which lithium can be dissolved and precipitated or a material into and from which lithium ions can be inserted and extracted can be used for the negative electrode active material; for example, a lithium metal, a carbon-based material, an alloy-based material, or the like can be used.

The lithium metal is preferable because of its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) while lithium ions are intercalated into the graphite (while a lithium-graphite intercalation compound is formed). For this reason, a lithium-ion secondary battery can have a high operating voltage. In addition, graphite is preferable because of its advantages such as relatively high capacity per unit volume, small volume expansion, low cost, and safety greater than that of a lithium metal.

For the negative electrode active material, an alloy-based material which enables charge-discharge reactions by an alloying reaction and a dealloying reaction with lithium can be used. In the case where carrier ions are lithium ions, a material containing at least one of Al, Si, Ge, Sn, Pb, Sb, Bi, Ag, Au, Zn, Cd, In, Ga, and the like can be used for example. Such elements have higher capacity than carbon. In particular, silicon has a significantly high theoretical capacity of 4200 mAh/g. For this reason, silicon is preferably used as the negative electrode active material. Examples of the alloy-based material using such elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, for the negative electrode active material, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used for the negative electrode active material by extracting the lithium ions contained in the positive electrode active material in advance.

Alternatively, a material which causes a conversion reaction can be used as the negative electrode active material; for example, a transition metal oxide which does not cause an alloy reaction with lithium, such as cobalt oxide (CoO), nickel oxide (NiO), or iron oxide (FeO), may be used. Other examples of the material which causes a conversion reaction include oxides such as Fe₂O₃, CuO, Cu₂O, RuO₂, and Cr₂O₃, sulfides such as CoS_{0.89}, NiS, or CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as a positive electrode active material because of its high potential.

### <Binder>

As the binder, polyvinylidene fluoride (PVDF) as a typical example, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose, or the like can be used.

### <Conductive Additive>

As a conductive additive, a material that has a large specific surface area is preferably used; for example, acetylene black (AB) can be used. Alternatively, a carbon material such as a carbon nanotube, graphene, or fullerene can be used.

Graphene is flaky and has an excellent electrical characteristic of high conductivity and excellent physical properties of high flexibility and high mechanical strength. Thus, the use of graphene as the conductive additive can increase contact points and the contact area of active materials.

Note that graphene in this specification refers to single-layer graphene or multilayer graphene including two or more and a hundred or less layers. Single-layer graphene refers to a one-atom-thick sheet of carbon molecules having π bonds. Graphene oxide refers to a compound formed by oxidation of such graphene. When graphene oxide is reduced to form graphene, oxygen contained in the graphene oxide is not entirely released and part of the oxygen remains in the graphene. When the graphene contains oxygen, the proportion of the oxygen, which is measured by X-ray photoelectron spectroscopy (XPS), is higher than or equal to 2 at. % and lower than or equal to 20 at. %, preferably higher than or equal to 3 at. % and lower than or equal to 15 at. %.

In the case where graphene is multilayer graphene including graphene obtained by reducing graphene oxide, the interlayer distance between graphenes is greater than 0.34 nm and less than or equal to 0.5 nm, preferably greater than or equal to 0.38 nm and less than or equal to 0.42 nm, more preferably greater than or equal to 0.39 nm and less than or equal to 0.41 nm. In general graphite, the interlayer distance between single-layer graphenes is 0.34 nm. Since the interlayer distance between the graphenes obtained by reducing graphene oxides is longer than that in general graphite, carrier ions can easily transfer between the graphenes in multilayer graphene.

As the conductive additive, metal powder or metal fibers of copper, nickel, aluminum, silver, gold, or the like, a conductive ceramic material, or the like can alternatively be used instead of the above carbon material.

Here, an active material layer including graphenes as a conductive additive will be described with reference to FIG. 9C.

FIG. 9C is an enlarged longitudinal cross-sectional view of the active material layer 414. The active material layer 414 includes active material particles 422, graphenes 424 as a conductive additive, and a binder (not illustrated).

The longitudinal cross section of the active material layer 414 shows substantially uniform dispersion of the sheet-like graphenes 424 in the active material layer 414. The graphenes 424 are schematically shown by thick lines in FIG. 9C but are actually thin films each having a thickness corresponding to the thickness of a single layer or a multi-layer of carbon molecules. The plurality of graphenes 424 are formed in such a way as to wrap, coat, or be adhered to a plurality of the active material particles 422, so that the graphenes 424 make surface contact with the plurality of the active material particles 422. Further, the graphenes 424 are also in surface contact with each other; consequently, the plurality of graphenes 424 form a three-dimensional network for electronic conduction.

This is because graphene oxides with extremely high dispersibility in a polar solvent are used as materials of the graphenes 424. The solvent is removed by volatilization from a dispersion medium containing the graphene oxides uniformly dispersed and the graphene oxides are reduced to give graphenes; hence, the graphenes 424 remaining in the active material layer 414 partly overlap with each other and are dispersed such that surface contact is made, thereby forming a path for electronic conduction.

Unlike a conductive additive in the form of particles, such as acetylene black, which makes point contact with an active material 422, the graphenes 424 are capable of surface contact with low contact resistance; accordingly, the electronic conduction of the active material particles 422 and the graphenes 424 can be improved without an increase in the amount of a conductive additive. Thus, the proportion of the active material particles 422 in the active material layer 414 can be increased. Accordingly, the discharge capacity of a storage battery can be increased.

### <Electrolytic Solution>

As an electrolyte in the electrolytic solution 406, a material which contains carrier ions is used. Typical examples of the electrolyte are lithium salts such as LiPF₆, LiClO₄, Li(FSO₂)₂N, LiAsF₆, LiBF₄, LiCF₃SO₃, Li(CF₃SO₂)₂N, and Li(C₂F₅SO₂)₂N. One of these electrolytes may be used alone or two or more of them may be used in an appropriate combination and in an appropriate ratio. In order to stabilize a decomposition reaction product layer, a small amount (1 wt %) of vinylene carbonate (VC) may be added to the electrolytic solution so that the decomposition amount of the electrolytic solution is further reduced.

Note that when carrier ions are alkali metal ions other than lithium ions, or alkaline-earth metal ions, instead of lithium in the above lithium salts, an alkali metal (e.g., sodium or potassium) or an alkaline-earth metal (e.g., calcium, strontium, barium, beryllium, or magnesium) may be used for the electrolyte.

As a solvent of the electrolytic solution 406, a material in which carrier ions can transfer is used. As the solvent of the electrolytic solution 406, an aprotic organic solvent is preferably used. Typical examples of aprotic organic solvents include ethylene carbonate (EC), propylene carbonate, dimethyl carbonate, diethyl carbonate (DEC), γ-butyrolactone, acetonitrile, dimethoxyethane, tetrahydrofuran, and the like, and one or more of these materials can be used. When a gelled high-molecular material is used as the solvent of the electrolytic solution 406, safety against liquid leakage and the like is improved. Further, the storage battery can be thinner and more lightweight. Typical examples of gelled high-molecular materials include a silicone gel, an acrylic gel, an acrylonitrile gel, polyethylene oxide, polypropylene oxide, a fluorine-based polymer, and the like. Alternatively, the use of one or more of ionic liquids (room temperature molten salts) which have features of non-flammability and non-volatility as a solvent of the electrolytic solution 406 can prevent the storage battery from exploding or catching fire even when the storage battery internally shorts out or the internal temperature increases owing to overcharge or the like.

Instead of the electrolytic solution 406, a solid electrolyte including an inorganic material such as a sulfide-based inorganic material or an oxide-based inorganic material, or a solid electrolyte including a macromolecular material such as a polyethylene oxide (PEO)-based macromolecular material may alternatively be used. When the solid electrolyte is used, a separator or a spacer is not necessary. Further, the battery can be entirely solidified; therefore, there is no possibility of liquid leakage and thus the safety of the battery is dramatically increased.

### <Separator>

As the separator 408, an insulator such as cellulose (paper), polypropylene with pores, or polyethylene with pores can be used.

Dross can be a conductor or an insulator depending on an electrode material or a material of a liquid substance in contact with the electrode. Such dross might serve as a conductor that changes a current path to cause a short circuit, or might serve as an insulator to hinder passage of current.

This embodiment can be applied to any battery that has a structure where such dross is formed.

According to this embodiment, as well as batteries, any electrochemical device which might deteriorate due to formation of dross can be prevented from deteriorating or the degree of deterioration of the electrochemical device can be reduced, leading to improvement of long-term reliability of the electrochemical device.

### Embodiment 2

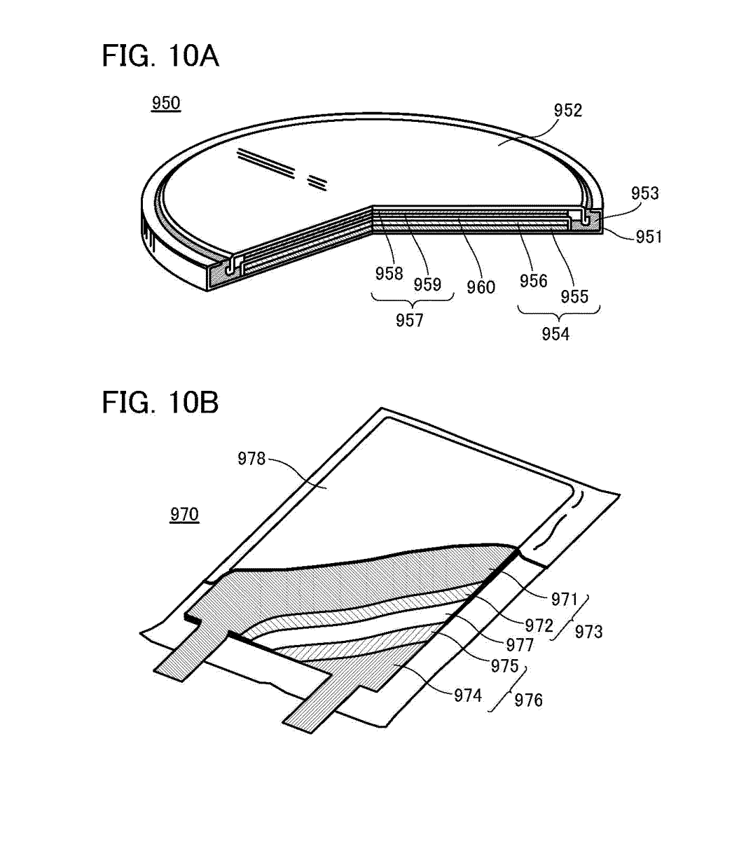

In this embodiment, structures of nonaqueous secondary batteries will be described with reference to FIGS. 10A and 10B, FIGS. 11A and 11B, and FIGS. 12A to 12C.

FIG. 10A is an external view of a coin-type (single-layer flat type) battery, part of which illustrates a cross-sectional structure of the coin-type battery.

In a coin-type battery 950, a positive electrode can 951 also serving as a positive electrode terminal and a negative electrode can 952 also serving as a negative electrode terminal are insulated and sealed with a gasket 953 formed of polypropylene or the like. A positive electrode 954 includes a positive electrode current collector 955 and a positive electrode active material layer 956 which is provided in contact with the positive electrode current collector 955. A negative electrode 957 includes a negative electrode current collector 958 and a negative electrode active material layer 959 which is provided in contact with the negative electrode current collector 958. A separator 960 and an electrolytic solution (not illustrated) are included between the positive electrode active material layer 956 and the negative electrode active material layer 959.

The negative electrode 957 includes the negative electrode active material layer 959 and the negative electrode current collector 958. The positive electrode 954 includes the positive electrode active material layer 956 and the positive electrode current collector 955.

For the positive electrode 954, the negative electrode 957, the separator 960, and the electrolytic solution, the above-described members can be used.

For the positive electrode can 951 and the negative electrode can 952, a metal having corrosion resistance to an electrolytic solution, such as nickel, aluminum, or titanium, an alloy of such a metal, or an alloy of such a metal and another metal (e.g., stainless steel or the like) can be used. Alternatively, the positive electrode can 951 and the negative electrode can 952 are preferably covered with nickel, aluminum, or the like in order to prevent corrosion caused by the electrolytic solution. The positive electrode can 951 and the negative electrode can 952 are electrically connected to the positive electrode 954 and the negative electrode 957, respectively.

The negative electrode 957, the positive electrode 954, and the separator 960 are immersed in the electrolytic solution. Then, as illustrated in FIG. 10A, the positive electrode can 951, the positive electrode 954, the separator 960, the negative electrode 957, and the negative electrode can 952 are stacked in this order with the positive electrode can 951 positioned at the bottom, and the positive electrode can 951 and the negative electrode can 952 are subjected to pressure bonding with the gasket 953 interposed therebetween. In such a manner, the coin-type battery 950 is fabricated.

Next, an example of a laminated secondary battery will be described with reference to FIG. 10B. In FIG. 10B, a structure inside the laminated secondary battery is partly exposed for convenience.

A laminated battery 970 using a laminate film as an exterior body and illustrated in FIG. 10B includes a positive electrode 973 including a positive electrode current collector 971 and a positive electrode active material layer 972, a negative electrode 976 including a negative electrode current collector 974 and a negative electrode active material layer 975, a separator 977, an electrolytic solution (not illustrated), and an exterior body 978. The separator 977 is provided between the positive electrode 973 and the negative electrode 976 in the exterior body 978. The exterior body 978 is filled with the electrolytic solution. Although the one positive electrode 973, the one negative electrode 976, and the one separator 977 are used in FIG. 10B, the secondary battery may have a layered structure in which positive electrodes and negative electrodes are alternately stacked and separated by separators.

For the positive electrode 973, the negative electrode 976, the separator 977, and the electrolytic solution (an electrolyte and a solvent), the above-described members can be used.

In the laminated battery 970 illustrated in FIG. 10B, the positive electrode current collector 971 and the negative electrode current collector 974 also serve as terminals (tabs) for an electrical contact with an external portion. For this reason, each of the positive electrode current collector 971 and the negative electrode current collector 974 is arranged so that part of the positive electrode current collector 971 and part of the negative electrode current collector 974 are exposed on the outside the exterior body 978.

As the exterior body 978 in the laminated battery 970, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used. With such a three-layer structure, permeation of the electrolytic solution and a gas can be blocked and an insulating property can be obtained.

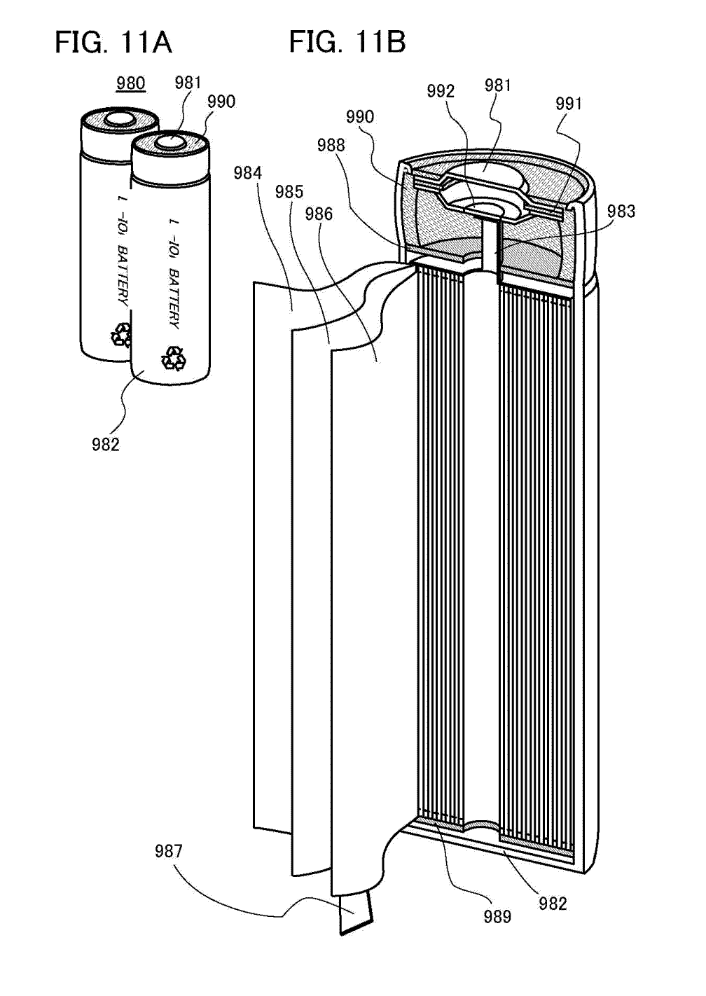

Next, an example of a cylindrical battery will be described with reference to FIGS. 11A and 11B. As illustrated in FIG. 11A, a cylindrical secondary battery 980 includes a positive electrode cap (battery cap) 981 on the top surface and a battery can (outer can) 982 on the side surface and bottom surface. The positive electrode cap 981 and the battery can 982 are insulated by the gasket 990 (insulating packing).

FIG. 11B is a schematic view of a cross-section of the cylindrical secondary battery 980. Inside the battery can 982 having a hollow cylindrical shape, a battery element in which a strip-like positive electrode 984 and a strip-like negative electrode 986 are wound with a stripe-like separator 985 provided therebetween is provided. Although not illustrated, the battery element is wound around a center pin. The battery can 982 is closed at one end and opened at the other end.

For the positive electrode 984, the negative electrode 986, and the separator 985, the above-described members can be used.

For the battery can 982, a metal having corrosion resistance to an electrolytic solution, such as nickel, aluminum, or titanium, an alloy of such a metal, or an alloy of such a metal and another metal (e.g., stainless steel or the like) can be used. Alternatively, the battery can 982 is preferably covered with nickel, aluminum, or the like in order to prevent corrosion caused by the electrolytic solution. Inside the battery can 982, the battery element in which the positive electrode, the negative electrode, and the separator are wound is provided between a pair of insulating plates 988 and 989 which face each other.

Further, an electrolytic solution (not illustrated) is injected inside the battery can 982 in which the battery element is provided. For the electrolytic solution, the above-described electrolyte and solvent can be used.

Since the positive electrode 984 and the negative electrode 986 of the cylindrical battery 980 are wound, active material layers are formed on both sides of the current collectors. A positive electrode terminal (positive electrode current collecting lead) 983 is connected to the positive electrode 984, and a negative electrode terminal (negative electrode current collecting lead) 987 is connected to the negative electrode 986. Both the positive electrode terminal 983 and the negative electrode terminal 987 can be formed using a metal material such as aluminum. The positive electrode terminal 983 and the negative electrode terminal 987 are resistance-welded to a safety valve mechanism 992 and the bottom of the battery can 982, respectively. The safety valve mechanism 992 is electrically connected to the positive electrode cap 981 through a positive temperature coefficient (PTC) element 991. The safety valve mechanism 992 cuts off electrical connection between the positive electrode cap 981 and the positive electrode 984 when the internal pressure of the battery 980 increases and exceeds a predetermined threshold value. The PTC element 991 is a heat sensitive resistor whose resistance increases as temperature rises, and controls the amount of current by an increase in resistance to prevent unusual heat generation of the battery 980. Barium titanate (BaTiO₃)-based semiconductor ceramic or the like can be used for the PTC element 991.

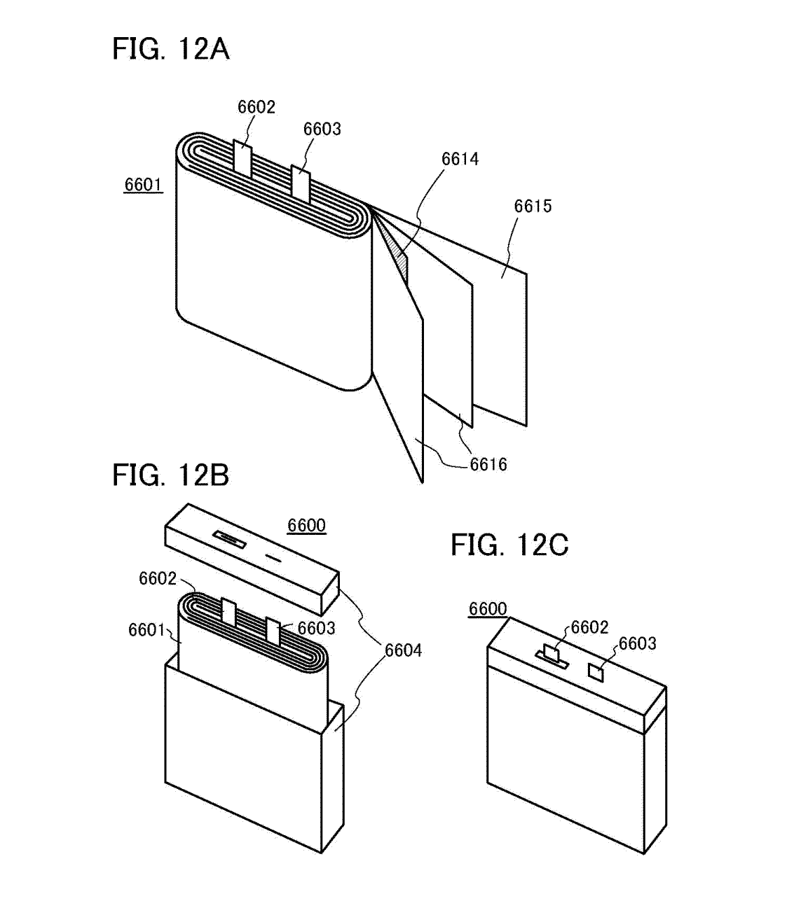

Next, an example of a rectangular secondary battery will be described with reference to FIG. 12A. A wound body 6601 illustrated in FIG. 12A includes a terminal 6602 and a terminal 6603. The wound body 6601 is obtained by winding a sheet of a stack in which a negative electrode 6614 overlaps with a positive electrode 6615 with a separator 6616 provided therebetween. The wound body 6601 is covered with a rectangular sealing can 6604 or the like as illustrated in FIG. 12B; thus, a rectangular secondary battery 6600 is fabricated. Note that the number of stacks each including the negative electrode 6614, the positive electrode 6615, and the separator 6616 may be determined as appropriate depending on required capacity of the battery 6660 and the volume of the sealing can 6604. FIG. 12C illustrates the sealing can 6604 that is closed.

Next, description will be given of a lithium-ion capacitor, which is an example of power storage devices.

A lithium-ion capacitor is a hybrid capacitor which combines a positive electrode of an electric double layer capacitor (EDLC) and a negative electrode of a lithium-ion secondary battery using a carbon material, and also an asymmetric capacitor in which the principles of power storage are different between the positive electrode and the negative electrode. The positive electrode enables charge and discharge by a physical action making use of an electrical double layer, whereas the negative electrode enables charge and discharge by a chemical action of lithium. A negative electrode in which lithium is received in a negative electrode active material such as a carbon material is used, whereby energy density is much higher than that of a conventional electric double layer capacitor whose negative electrode is formed using activated carbon.

In a lithium-ion capacitor, instead of a positive electrode active material layer in a lithium-ion secondary battery, a material that can reversibly adsorb at least one of lithium ions and anions is used. Examples of such a material are activated carbon, a conductive high molecule, and a polyacenic semiconductor (PAS).

The lithium-ion capacitor has high efficiency of charge and discharge, has capability of rapidly performing charge and discharge, and has a long life even when it is repeatedly used.

Such a lithium-ion capacitor can be used as the power storage device of one embodiment of the present invention. Thus, generation of irreversible capacity can be reduced, so that a power storage device having improved cycle characteristics can be manufactured.

This embodiment can be freely combined with any of the other embodiments. Specifically, a reaction product is dissolved by supplying, to the electrochemical device obtained according to this embodiment, such as a battery, a signal (inversion pulse current) with which a current flows in the reverse direction of a current with which a reaction product is formed; thus, deterioration of the electrochemical device is prevented or the degree of deterioration of the electrochemical device is reduced, and charge and discharge performance of the electrochemical device is maximized and maintained for a long time. Further, by supplying, to the electrochemical device obtained according to this embodiment, a signal (inversion pulse current) with which a current flows in the reverse direction of a current with which a reaction product is formed, it is possible to reduce defective products which suddenly become dysfunctional from any cause although being charged and discharged without any problem when manufactured and shipped as quality products.

### Embodiment 3

The electrochemical device of one embodiment of the present invention can be used for power storage devices as power sources of a variety of electrical devices. Further, according to one embodiment of the present invention, a maintenance-free battery can be obtained by supplying, to an electrochemical device, a signal (inversion pulse current) with which a current flows in the reverse direction of a current with which a reaction product is formed.

Here, “electrical devices” refer to all general industrial products including portions which operate by electric power. Electrical devices are not limited to consumer products such as home electrical products and also include products for various uses such as business use, industrial use, and military use in their category. Examples of electrical devices each using the power storage device of one embodiment of the present invention are as follows: display devices of televisions, monitors, and the like, lighting devices, desktop personal computers, laptop personal computers, word processors, image reproduction devices which reproduce still images or moving images stored in recording media such as digital versatile discs (DVDs), portable or stationary music reproduction devices such as compact disc (CD) players and digital audio players, portable or stationary radio receivers, recording reproduction devices such as tape recorders and IC recorders (voice recorders), headphone stereos, stereos, remote controls, clocks such as table clocks and wall clocks, cordless phone handsets, transceivers, mobile phones, car phones, portable or stationary game machines, pedometers, calculators, portable information terminals, electronic notebooks, e-book readers, electronic translators, audio input devices such as microphones, cameras such as still cameras and video cameras, toys, electric shavers, electric toothbrushes, high-frequency heating appliances such as microwave ovens, electric rice cookers, electric washing machines, electric vacuum cleaners, water heaters, electric fans, hair dryers, air-conditioning systems such as humidifiers, dehumidifiers, and air conditioners, dishwashers, dish dryers, clothes dryers, futon dryers, electric refrigerators, electric freezers, electric refrigerator-freezers, freezers for preserving DNA, flashlights, electric power tools, smoke detectors, and a health equipment and a medical equipment such as hearing aids, cardiac pacemakers, portable X-ray equipments, radiation counters, electric massagers, and dialyzers. The examples also include industrial equipment such as guide lights, traffic lights, meters such as gas meters and water meters, belt conveyors, elevators, escalators, automatic vending machines, automatic ticket machine, cash dispensers (CD), automated teller machines (ATM), digital signage, industrial robots, radio relay stations, mobile phone base stations, power storage systems, and power storage devices for leveling the amount of power supply and smart grid.

Note that in the electrical devices, the power storage device of one embodiment of the present invention can be used as main power sources for supplying enough electric power for almost the whole power consumption. Alternatively, for the electrical devices, the power storage device of one embodiment of the present invention can be used as an uninterruptible power source which can supply power to the electrical devices when the supply of power from the main power sources or a commercial power source is stopped. Still alternatively, for the electrical devices, the power storage device of one embodiment of the present invention can be used as an auxiliary power source for supplying electric power to the electrical devices at the same time as the electrical devices are supplied with electric power from the main power sources or the commercial power source. When the power storage device of one embodiment of the present invention is used for as an auxiliary power source, a maintenance-free power storage device can be obtained by supplying, the power storage device obtained according to this embodiment, a signal (inversion pulse current) with which a current flows in the reverse direction of a current with which a reaction product is formed, resulting in a reduction in cost and time which are required for the maintenance of a fixed power source or power storage equipment. Although the maintenance of the fixed power source or power storage equipment requires considerable cost, a significant effect, such as a great reduction in cost for the maintenance, can be obtained by supplying a signal (inversion pulse current) with which a current flows in the reverse direction of a current with which a reaction product is formed.

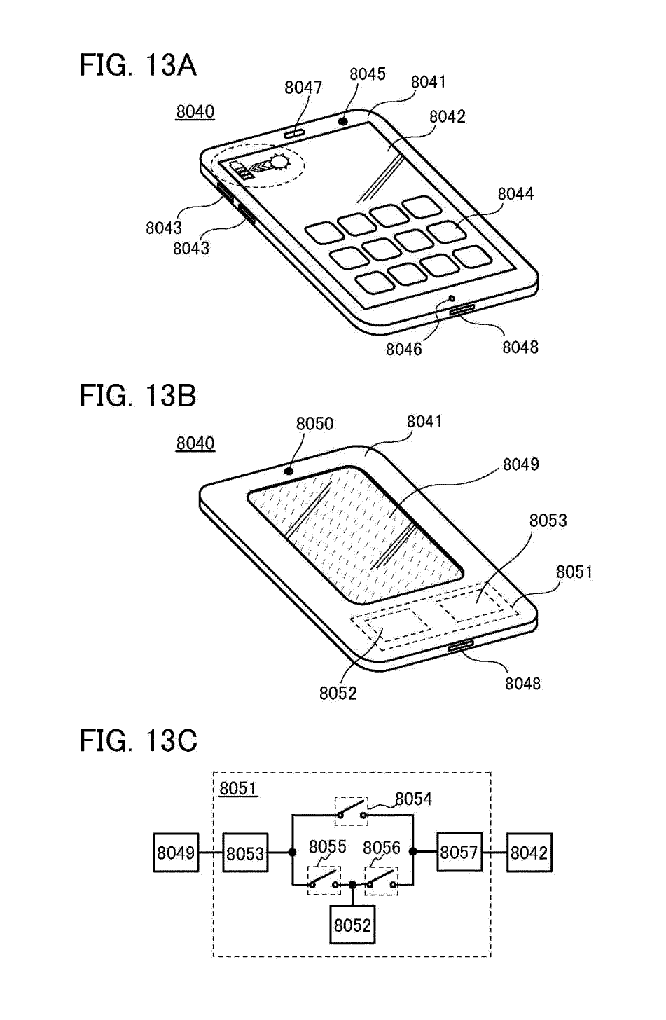

As another example of the electrical devices, a portable information terminal is described with reference to FIGS. 13A to 13C.

FIG. 13A is a perspective view illustrating a front surface and a side surface of a portable information terminal 8040. The portable information terminal 8040 is capable of executing a variety of applications such as mobile phone calls, e-mailing, viewing and editing texts, music reproduction, Internet communication, and a computer game. In the portable information terminal 8040, a housing 8041 includes a display portion 8042, a camera 8045, a microphone 8046, and a speaker 8047 on its front surface, a button 8043 for operation on its left side, and a connection terminal 8048 on its bottom surface.

A display module or a display panel is used for the display portion 8042. Examples of the display module or the display panel are a light-emitting device in which each pixel includes a light-emitting element typified by an organic light-emitting element (OLED); a liquid crystal display device; an electronic paper performing a display in an electrophoretic mode, an electronic liquid powder (registered trademark) mode, or the like; a digital micromirror device (DMD); a plasma display panel (PDP); a field emission display (FED); a surface conduction electron-emitter display (SED); a light-emitting diode (LED) display; a carbon nanotube display; a nanocrystal display; and a quantum dot display.

The portable information terminal 8040 illustrated in FIG. 13A is an example of providing the one display portion 8042 in the housing 8041; however, one embodiment of the present invention is not limited to this example. The display portion 8042 may be provided on a rear surface of the portable information terminal 8040. Further, the portable information terminal 8040 may be a foldable portable information terminal in which two or more display portions are provided.

A touch panel with which data can be input by an instruction means such as a finger or a stylus is provided as an input means on the display portion 8042. Therefore, icons 8044 displayed on the display portion 8042 can be easily operated by the instruction means. Since the touch panel is provided, a region for a keyboard on the portable information terminal 8040 is not needed and thus the display portion can be provided in a large region. Further, since data can be input with a finger or a stylus, a user-friendly interface can be obtained. Although the touch panel may be of any of various types such as a resistive type, a capacitive type, an infrared ray type, an electromagnetic induction type, and a surface acoustic wave type, the resistive type or the capacitive type is particularly preferable because the display portion 8042 can be curved. Furthermore, such a touch panel may be what is called an in-cell touch panel, in which a touch panel is integral with the display module or the display panel.

The touch panel may also function as an image sensor. In this case, for example, an image of a palm print, a fingerprint, or the like is taken with the display portion 8042 touched with the palm or the finger, whereby personal authentication can be performed. Furthermore, with the use of backlight or a sensing light source emitting near-infrared light for the display portion 8042, an image of a finger vein, a palm vein, or the like can also be taken.

Further, instead of the touch panel, a keyboard may be provided in the display portion 8042. Furthermore, both the touch panel and the keyboard may be provided.

The button 8043 for operation can have various functions in accordance with the intended use. For example, the button 8043 may be used as a home button so that a home screen is displayed on the display portion 8042 by pressing the button 8043. Further, the portable information terminal 8040 may be configured such that main power source thereof is turned off with a press of the button 8043 for a predetermined time. A structure may also be employed in which a press of the button 8043 brings the portable information terminal 8040 which is in a sleep mode out of the sleep mode. Besides, the button can be used as a switch for starting a variety of functions, for example, depending on the length of time for pressing or by pressing the button at the same time as another button.

Further, the button 8043 may be used as a volume control button or a mute button to have a function of adjusting the volume of the speaker 8047 for outputting sound, for example. The speaker 8047 outputs various kinds of sound, examples of which are sound set for predetermined processing, such as startup sound of an operating system (OS), sound from sound files executed in various applications, such as music from music reproduction application software, and an incoming e-mail alert. Although not illustrated, a connector for outputting sound to a device such as headphones, earphones, or a headset may be provided together with or instead of the speaker 8047 for outputting sound.

As described above, the button 8043 can have various functions. Although the number of the button 8043 is two in the portable information terminal 8040 in FIG. 13A, it is needless to say that the number, arrangement, position, or the like of the buttons is not limited to this example and can be designed as appropriate.

The microphone 8046 can be used for sound input and recording. Images obtained with the use of the camera 8045 can be displayed on the display portion 8042.

In addition to the operation with the touch panel provided on the display portion 8042 or the button 8043, the portable information terminal 8040 can be operated by recognition of user's movement (gesture) (also referred to as gesture input) using the camera 8045, a sensor provided in the portable information terminal 8040, or the like. Alternatively, the portable information terminal 8040 can be operated by recognition of user's voice (also referred to as voice input) with the use of the microphone 8046. By introducing a natural user interface (NUI) technique which enables data to be input to an electrical device by natural behavior of a human, the operational performance of the portable information terminal 8040 can be further improved.

The connection terminal 8048 is a terminal for inputting a signal at the time of communication with an external device or inputting electric power at the time of power supply. For example, the connection terminal 8048 can be used for connecting an external memory drive to the portable information terminal 8040. Examples of the external memory drive are storage medium drives such as an external hard disk drive (HDD), a flash memory drive, a digital versatile disk (DVD) drive, a DVD-recordable (DVD-R) drive, a DVD-rewritable (DVD-RW) drive, a compact disc (CD) drive, a compact disc recordable (CD-R) drive, a compact disc rewritable (CD-RW) drive, a magneto-optical (MO) disc drive, a floppy disk drive (FDD), and other nonvolatile solid state drive (SSD) devices. Although the portable information terminal 8040 has the touch panel on the display portion 8042, a keyboard may be provided on the housing 8041 instead of the touch panel or may be externally added.

Although the number of the connection terminal 8048 is one in the portable information terminal 8040 in FIG. 13A, it is needless to say that the number, arrangement, position, or the like of the connection terminals is not limited to this example and can be designed as appropriate.

FIG. 13B is a perspective view illustrating the rear surface and the side surface of the portable information terminal 8040. In the portable information terminal 8040, the housing 8041 includes a solar cell 8049 and a camera 8050 on its rear surface; the portable information terminal 8040 further includes a charge and discharge control circuit 8051, a power storage device 8052, a DC-DC converter 8053, and the like. FIG. 13B illustrates an example where the charge and discharge control circuit 8051 includes the power storage device 8052 and the DC-DC converter 8053. The electrochemical device of one embodiment of the present invention described above can be used as the power storage device 8052.

The solar cell 8049 attached on the rear surface of the portable information terminal 8040 can supply electric power to the display portion, the touch panel, a video signal processor, and the like. Note that the solar cell 8049 can be provided on one or both surfaces of the housing 8041. By including the solar cell 8049 in the portable information terminal 8040, the power storage device 8052 in the portable information terminal 8040 can be charged even in a place where an electric power supply unit is not provided, such as outdoors.

As the solar cell 8049, it is possible to use any of the following: a silicon-based solar cell including a single layer or a stacked layer of single crystal silicon, polycrystalline silicon, microcrystalline silicon, or amorphous silicon; an InGaAs-based, GaAs-based, CIS-based, Cu₂ZnSnS₄-based, or CdTe—CdS-based solar cell; a dye-sensitized solar cell including an organic dye; an organic thin film solar cell including a conductive polymer, fullerene, or the like; a quantum dot solar cell having a pin structure in which a quantum dot structure is formed in an i-layer with silicon or the like; and the like.

Here, an example of a structure and operation of the charge and discharge control circuit 8051 illustrated in FIG. 13B is described with reference to a block diagram in FIG. 13C.

FIG. 13C illustrates the solar cell 8049, the power storage device 8052, the DC-DC converter 8053, a converter 8057, a switch 8054, a switch 8055, a switch 8056, and the display portion 8042. The power storage device 8052, the DC-DC converter 8053, the converter 8057, and the switches 8054 to 8056 correspond to the charge and discharge control circuit 8051 in FIG. 13B.

The voltage of electric power generated by the solar cell 8049 with the use of external light is raised or lowered by the DC-DC converter 8053 to be at a level needed for charging the power storage device 8052. When electric power from the solar cell 8049 is used for the operation of the display portion 8042, the switch 8054 is turned on and the voltage of the electric power is raised or lowered by the converter 8057 to a voltage needed for operating the display portion 8042. In addition, when display on the display portion 8042 is not performed, the switch 8054 is turned off and the switch 8055 is turned on so that the power storage device 8052 may be charged.

Although the solar cell 8049 is described as an example of a power generation means, the power generation means is not particularly limited thereto, and the power storage device 8052 may be charged by another power generation means such as a piezoelectric element or a thermoelectric conversion element (Peltier element). The charging method of the power storage device 8052 in the portable information terminal 8040 is not limited thereto, and the connection terminal 8048 may be connected to a power source to perform charge, for example. The power storage device 8052 may be charged by a non-contact power transmission module performing charge by transmitting and receiving electric power wirelessly, or any of the above charging methods may be used in combination.

Here, the state of charge (SOC) of the power storage device 8052 is displayed on the upper left corner (in the dashed frame in FIG. 13A) of the display portion 8042. Thus, the user can check the state of charge of the power storage device 8052 and can accordingly switch the operation mode of the portable information terminal 8040 to a power saving mode. When the user selects the power saving mode, for example, the button 8043 or the icons 8044 can be operated to switch the components of the portable information terminal 8040, e.g., the display module or the display panel, an arithmetic unit such as CPU, and a memory, to the power saving mode. Specifically, in each of the components, the use frequency of a given function is decreased to stop the use. Further, the portable information terminal 8040 can be configured to be automatically switched to the power saving mode depending on the state of charge. Furthermore, by providing a sensor such as an optical sensor in the portable information terminal 8040, the amount of external light at the time of using the portable information terminal 8040 is sensed to optimize display luminance, which makes it possible to reduce the power consumption of the power storage device 8052.

In addition, when charging with the use of the solar cell 8049 or the like is performed, an image or the like showing that the charging is performed with the solar cell may be displayed on the upper left corner (in the dashed frame) of the display portion 8042 as illustrated in FIG. 13A.

It is needless to say that one embodiment of the present invention is not limited to the electrical device illustrated in FIGS. 13A to 13C as long as the power storage device of one embodiment of the present invention is included.

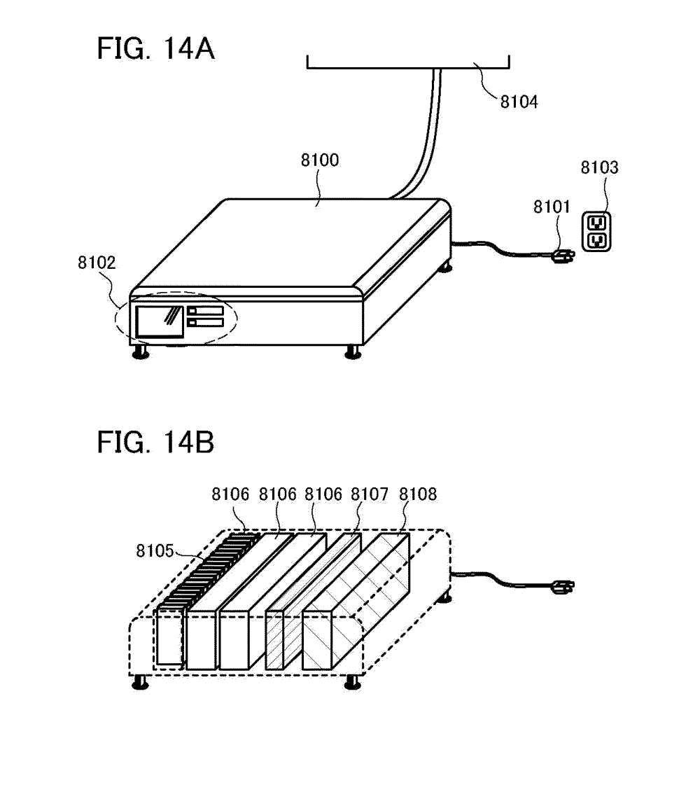

Moreover, a power storage system will be described as another example of the electrical devices with reference to FIGS. 14A and 14B. A power storage device 8100 to be described here can be used at home as the power storage device 8000 described above. Here, the power storage device 8100 is described as a home-use power storage system as an example; however, it is not limited thereto and can also be used for business use or other uses.

As illustrated in FIG. 14A, the power storage device 8100 includes a plug 8101 for being electrically connected to a system power supply 8103. Further, the power storage device 8100 is electrically connected to a panelboard 8104 installed in home.

The power storage device 8100 may further include a display panel 8102 for displaying an operation state or the like, for example. The display panel may have a touch screen. In addition, the power storage device 8100 may include a switch for turning on and off a main power source, a switch to operate the power storage system, and the like as well as the display panel.

Although not illustrated, an operation switch to operate the power storage device 8100 may be provided separately from the power storage device 8100; for example, the operation switch may be provided on a wall in a room. Alternatively, the power storage device 8100 may be connected to a personal computer, a server, or the like provided in home, in order to be operated indirectly. Still alternatively, the power storage device 8100 may be remotely operated using the Internet, an information terminal such as a smartphone, or the like. In such cases, a mechanism that performs wired or wireless communication between the power storage device 8100 and other devices is provided in the power storage device 8100.

FIG. 14B is a schematic view illustrating the inside of the power storage device 8100. The power storage device 8100 includes a plurality of battery groups 8106, a battery management unit (BMU) 8107, and a power conditioning system (PCS) 8108.

In the battery group 8106, a plurality of batteries 8105 are connected to each other. Electric power from the system power supply 8103 can be stored in the battery group 8106. The plurality of battery groups 8106 are each electrically connected to the BMU 8107.

The BMU 8107 has functions of monitoring and controlling states of the plurality of batteries 8105 in the battery group 8106 and protecting the batteries 8105. Specifically, the BMU 8107 collects data of cell voltages and cell temperatures of the plurality of batteries 8105 in the battery group 8106, monitors overcharge and overdischarge, monitors overcurrent, controls a cell balancer, manages the deterioration condition of a battery, calculates the remaining battery level (the state of charge (SOC)), controls a cooling fan of a driving power storage device, or controls detection of failure, for example. Note that the batteries 8105 may have some of or all the functions, or the battery groups 8106 may have the functions. The BMU 8107 is electrically connected to the PCS 8108.

Overcharge means that charge is further performed in a state of full charge, and overdischarge means that discharge is further performed to the extent that the capacity is reduced so that operation becomes impossible. Overcharge can be prevented by monitoring the voltage of a battery during charge so that the voltage does not exceed a specified value (allowable value), for example. Overdischarge can be prevented by monitoring the voltage of a battery during discharge so that the voltage does not become lower than a specified value (allowable value).

Overcurrent refers to a current exceeding a specified value (allowable value). Overcurrent of a battery is caused when a positive electrode and a negative electrode are short-circuited in the battery or the battery is under an extremely heavy load, for example. Overcurrent can be prevented by monitoring a current flowing through a battery.

The PCS 8108 is electrically connected to the system power supply 8103, which is an AC power source and performs DC-AC conversion. For example, the PCS 8108 includes an inverter, a system interconnection protective device that detects irregularity of the system power supply 8103 and terminates its operation, and the like. In charging the power storage device 8100, for example, AC power from the system power supply 8103 is converted into DC power and transmitted to the BMU 8107. In discharging the power storage device 8100, electric power stored in the battery group 8106 is converted into AC power and supplied to an indoor load, for example. Note that the electric power may be supplied from the power storage device 8100 to the load through the panelboard 8104 as illustrated in FIG. 14A or may be directly supplied from the power storage device 8100 through wired or wireless transmission.

The above electrical devices may each include a power storage device or may be connected wirelessly or with a wiring to one or more of power storage devices and a control device controlling these electric power systems to form a network (electric power network). The network of the electric power systems that is controlled by the control device can improve efficiency in the use of electric power in the whole network.

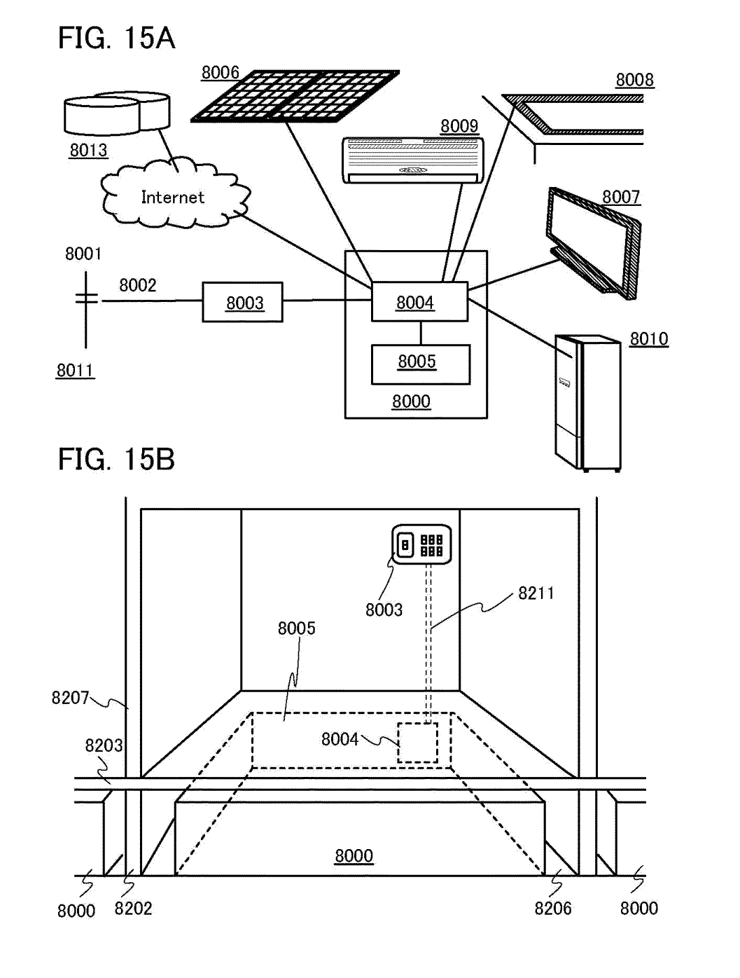

FIG. 15A illustrates an example of a home energy management system (HEMS) in which a plurality of home appliances, a control device, a battery, and the like are connected in a house. Such a system makes it possible to easily check the power consumption of the whole house. In addition, the plurality of home appliances can be operated with a remote control. Further, automatic control of the home appliances with a sensor or the control device can also contribute to reduction in power consumption.

The power storage device 8000 includes a management device 8004 and a battery 8005.

A panelboard 8003 set in a house is connected to an electric power system 8001 through an incoming line 8002. The panelboard 8003 supplies AC power that is commercial electric power supplied through the incoming line 8002 to each of the plurality of home appliances. A management device 8004 is connected to the panelboard 8003 and also connected to the plurality of home appliances, a power storage device 8000, a solar power generation system 8006, and the like.

The management device 8004 connects the panelboard 8003 to the plurality of home appliances to form a network, and controls and manages the operation of the plurality of home appliances connected to the network.

In addition, the management device 8004 is connected to Internet 8011 and thus can be connected to a management server 8013 through the Internet 8011. The management server 8013 can receive data on status of use of electric power by users and create a database and thus can provide the users with a variety of services based on the database. Further, as needed, the management server 8013 can provide the users with data on electric power charge for a corresponding time zone, for example. On the basis of the data, the management device 8004 can set an optimized usage pattern in the house.

Examples of the plurality of home appliances are a display device 8007, a lighting device 8008, an air-conditioning system 8009, and an electric refrigerator 8010 illustrated in FIG. 15A. However, it is needless to say that the plurality of home appliances are not limited to these examples and refer to a variety of electrical devices that can be set inside a house, such as the above electrical devices.

In a display portion of the display device 8007, a semiconductor display device such as a liquid crystal display device, a light-emitting device including a light-emitting element, e.g., an organic electroluminescent (EL) element, in each pixel, an electrophoretic display device, a digital micromirror device (DMD), a plasma display panel (PDP), or a field emission display (FED) is provided, for example. A display device functioning as a display device for displaying information, such as a display device for TV broadcast reception, a personal computer, advertisement, or the like, is included in the category of the display device 8007.

The lighting device 8008 includes an artificial light source which generates light artificially by utilizing electric power in its category. Examples of the artificial light source are an incandescent lamp, a discharge lamp such as a fluorescent lamp, and light-emitting elements such as a light-emitting diode (LED) and an organic EL element. Although provided on a ceiling in FIG. 15A, the lighting device 8008 may be installation lighting provided on a wall, a floor, a window, or the like or desktop lighting.

The air-conditioning system 8009 has a function of adjusting an indoor environment such as temperature, humidity, and air cleanliness. FIG. 15A illustrates an air conditioner as an example. The air conditioner includes an indoor unit incorporating a compressor, an evaporator, and the like and an outdoor unit (not illustrated) incorporating a condenser, or an integral unit thereof.

The electric refrigerator 8010 is an electrical device for the storage of food and the like at low temperature and includes a freezer for freezing food and the like at 0° C. or lower. A refrigerant in a pipe which is compressed by a compressor absorbs heat when vaporized, and thus the inside of the electric refrigerator 8010 is cooled.

The plurality of home appliances may each include a battery or may use electric power supplied from the battery 8005 or a commercial power source without including the battery. By using a power storage device as an uninterruptible power source, the plurality of home appliances each including the power storage device 8000 can be used even when electric power cannot be supplied from the commercial power source due to power failure or the like.

In the vicinity of a terminal for power supply in each of the above home appliances, an electric power sensor such as a current sensor can be provided. Data obtained with the electric power sensor is sent to the management device 8004, which makes it possible for users to check the amount of electric power used in the whole house. In addition, on the basis of the data, the management device 8004 can determine the distribution of electric power to be supplied to the plurality of home appliances, resulting in the efficient or economical use of electric power in the house.

In a time zone when the usage rate of electric power which can be supplied from the commercial power source is low, electric power is preferably stored in the battery 8005 from the commercial power source. In addition, the battery 8005 is preferably charged from the commercial power source in the nighttime, which is a time zone when electricity cost is low. Further, with the use of the solar power generation system 8006, the battery 8005 can be charged. Note that an object which is charged is not limited to the battery 8005, and a battery mounted on another device such as a home appliance may be the object which is charged.

Electric power stored in a variety of power sources such as the battery 8005 in such a manner is efficiently distributed by the management device 8004, resulting in the efficient or economical use of electric power in the house.

Further, the power storage device 8000 is stored in a space other than a room of the house as illustrated in FIG. 15B, whereby a living space is not consumed by the power storage device 8000. Note that the power storage device 8000 itself or an installation site is made to have resistance against fire and water in order to secure high level of safety of the power storage device 8000.

In a building such as a housing, an underfloor space 8206 is surrounded by a base portion 8202 and a floor 8203 as illustrated in FIG. 15B. The inside of the house is partitioned by an inner wall 8207. The power storage device 8000 is stored in the underfloor space 8206. In the case where there are a plurality of underfloor spaces 8206, the power storage devices 8000 can be stored in the respective underfloor spaces 8206. The management device 8004 of the power storage device 8000 is connected to the panelboard 8003 through a wiring 8211.

An inversion pulse current is supplied to the battery 8005 in the power storage device 8000 in charging or discharging; thus, when measures to prevent heat generation and ignition due to a short circuit of the battery 8005 are taken for such a space as the underfloor space 8206, the power storage device 8000 can be installed in the space.

This embodiment can be implemented in combination with any of the other embodiments as appropriate.

### Example 1

In this example, an electrochemical device that is supplied with an inversion pulse current in charging will be described in detail. A coin-type lithium-ion secondary battery was fabricated and a charging test was performed thereon in this example. Here, the battery subjected to the charging test is referred to as “Evaluation Cell 1”.

### <Fabrication of Evaluation Cell 1>

### (Formation of Positive Electrode)

First, lithium iron phosphate (LiFePO₄) whose surface was provided with a carbon layer and N-methylpyrrolidone (NMP) as a polar solvent were stirred and mixed in a mixer at 2000 rpm for 5 minutes, and ultrasonic vibration was applied to the mixture for 3 minutes. Further stirring and mixing were performed in the mixer at 2000 rpm for 1 minute. The same process was repeated five times.

Graphene oxide was added to this mixture, and stirring and mixing of the mixture in a mixer at 2000 rpm for 3 minutes were performed eight times. While being mixed eight times, the contents in a container were stirred with a spatula. Then, half of the total amount of PVDF used as a binder was added and the mixture was stirred and mixed in a mixer at 2000 rpm for 3 minutes. After that, the other half of PVDF was added and stirring and mixing were performed in the mixer at 2000 rpm for 3 minutes. Further, NMP was added to adjust the viscosity and stirring and mixing were performed in the mixer at 2000 rpm for 1 minute. Furthermore, NMP was added and stirring and mixing were performed in the mixer at 2000 rpm for 1 minute. The LiFePO₄ provided with the carbon layer, the graphene oxide, and the PVDF were weighed and adjusted so that the compounding ratio thereof (excluding the polar solvent) was 91.4:0.6:8 (wt %) in the formed mixture.

The mixture formed in such a manner was applied over aluminum foil subjected to base treatment at a rate of 10 mm/sec with the use of an applicator. This was dried in hot air at 80° C. for 40 minutes to volatilize the polar solvent, and then pressing was performed to compress an active material layer so that the thickness of the electrode was reduced by approximately 20%.

Next, heating was performed at 170° C. in a reduced pressure atmosphere for 10 hours so that the electrode is dried and the graphene oxide is reduced to form graphene serving as a conductive additive.

Then, pressing was performed again with a gap which is the same as that in the above pressing to compress the active material layer, and the compressed layer was stamped into a positive electrode for a power storage device.

The thickness and the density of the positive electrode formed through the above steps were 58 μm and 1.82 g/cm³, respectively. The amount of the positive electrode active material in the positive electrode was 9.7 mg/cm² and the single-electrode theoretical capacity was 1.6 mAh/cm².

### (Formation of Negative Electrode)

Next, a negative electrode of Evaluation Cell 1 was formed. For the negative electrode, a negative electrode active material provided with a silicon oxide film as a coating film was used. For the negative electrode active material, graphite particles with an average diameter of 9 μm (mesocarbon microbeads (MCMB)) were used. First, water and ethanol were added to Si(OEt)₄ and hydrochloric acid serving as a catalyst, and this mixture was stirred to form a Si(OEt)₄ solution. The compounding ratio of this solution was as follows: the Si(OEt)₄ was 1.8×10⁻² mol; the hydrochloric acid, 4.44×10⁻⁴ mol; the water, 1.9 ml; and the ethanol, 6.3 ml. Next, the Si(OEt)₄ solution to which graphite particles serving as the negative electrode active material were added was stirred in a dry room. Then, the solution was held at 70° C. in a humid environment for 20 hours so that the Si(OEt)₄ in the mixed solution of the Si(OEt)₄ solution and the ethanol to which the graphite was added was hydrolyzed and condensed. In other words, the Si(OEt)₄ in the solution was made to react with water in the air, so that a hydrolysis reaction gradually occurred, and the Si(OEt)₄ after the hydrolysis was condensed by a dehydration reaction following the hydrolysis reaction. In such a manner, gelled silicon oxide was attached to the surfaces of graphite particles. Then, drying was performed at 500° C. in the air for three hours, whereby graphite particles covered with a film formed of silicon oxide were formed.

The negative electrode active material provided with the silicon oxide film that is formed in the above manner, PVDF as a binder, and NMP (N-methylpyrrolidone) as a polar solvent were prepared. Stirring and mixing of these in a mixer at 2000 rpm for 10 minutes were performed three times to form a mixture. The negative electrode active material and the PVDF were weighed and adjusted so that the compounding ratio thereof (excluding the polar solvent) is 90:10 (wt %) in the formed mixture.

The mixture formed in such a manner was applied over copper foil serving as a current collector at a rate of 10 mm/sec with the use of an applicator. This was dried in hot air at 70° C. for 40 minutes to volatilize the polar solvent, and then heating was performed at 170° C. in a reduced pressure atmosphere for 10 hours so that the electrode was dried.

After that, pressing was performed to compress an active material layer so that the thickness of the electrode was reduced by approximately 15%. The compressed layer was stamped into the negative electrode of Evaluation Cell 1.

The thickness and the density of the negative electrode formed through the above steps were 90 μm and 1.3 g/cm³, respectively. The amount of the negative electrode active material in the negative electrode was 11.0 mg/cm² and the single-electrode theoretical capacity was 4.0 mAh/cm².

### (Fabrication of Evaluation Cell 1)

Evaluation Cell 1 was fabricated using the formed positive electrode and the formed negative electrode. Evaluation Cell 1 was a CR2032 coin-cell battery (20 mm in diameter and 3.2 mm high). An electrolytic solution was formed in such a manner that lithium hexafluorophosphate (LiPF₆) was dissolved at a concentration of 1 mol/L in a solution in which ethylene carbonate (EC) and diethyl carbonate (DEC) were mixed at a volume ratio of 3:7. As a separator, polypropylene (PP) was used.

### <Experiment: Supply of Inversion Pulse Current in Charging>

Initial charge of fabricated Evaluation Cell 1 was performed. In this case, a signal (inversion pulse current) for supplying a current between the positive electrode and the negative electrode in the reverse direction of a charging current was supplied to the positive electrode more than once while the initial charge was performed.

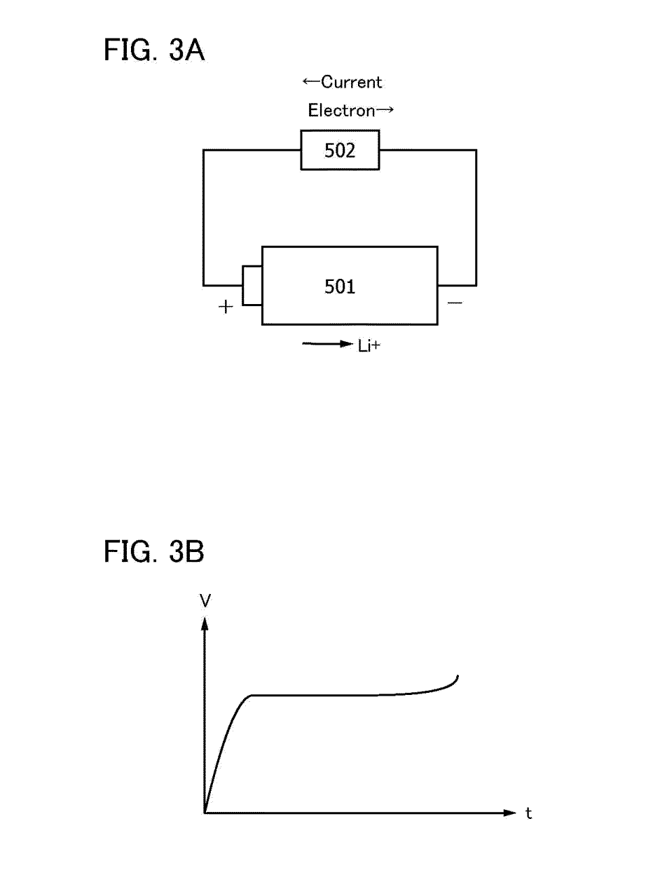

Here, the inversion pulse current refers to a current that flows in the reverse direction of a current with which a reaction of lithium intercalation into graphite (negative electrode active material) occurs and that flows in the reverse direction of a current with which a reaction product is formed (see FIG. 3A).

The charging method was constant current charging. The environment temperature was set to 25° C., the charge rate was set to 0.2 C (34 mA/g), and the charge termination voltage was set to 4.0 V. As for the inversion pulse current, the rate was 1 C (170 mA/g), the supply interval was 0.294 hours, and time for supplying the inversion pulse current (pulse width) was 0 seconds, 1 second, 5 seconds, and 10 seconds.

In other words, while a constant charging current was supplied between the positive electrode and the negative electrode, the inversion pulse current was supplied to the positive electrode at intervals of 18 minutes, and the inversion pulse current supply time was changed in the following order: 0 seconds, 1 second, 5 seconds, and 10 seconds.

The unit C indicates a charge rate and a discharge rate; 1 C means the amount of current per unit weight for fully charging a battery (Evaluation Cell 1, here) in an hour. In this example, when LiFePO₄ is used for the positive electrode of the battery and the theoretical capacity of the LiFePO₄ is 170 mAh/g, a charging current of 170 mA is 1 C (170 mA/g) assuming that the weight of the LiFePO₄ as the positive electrode is 1 g. In this case, an ideal battery is fully charged in an hour. Further, provided that 1 g of LiFePO₄ is a positive electrode, charging at a charge rate of 2 C means that charge is performed by supplying a charging current of 340 mA for 0.5 hours.

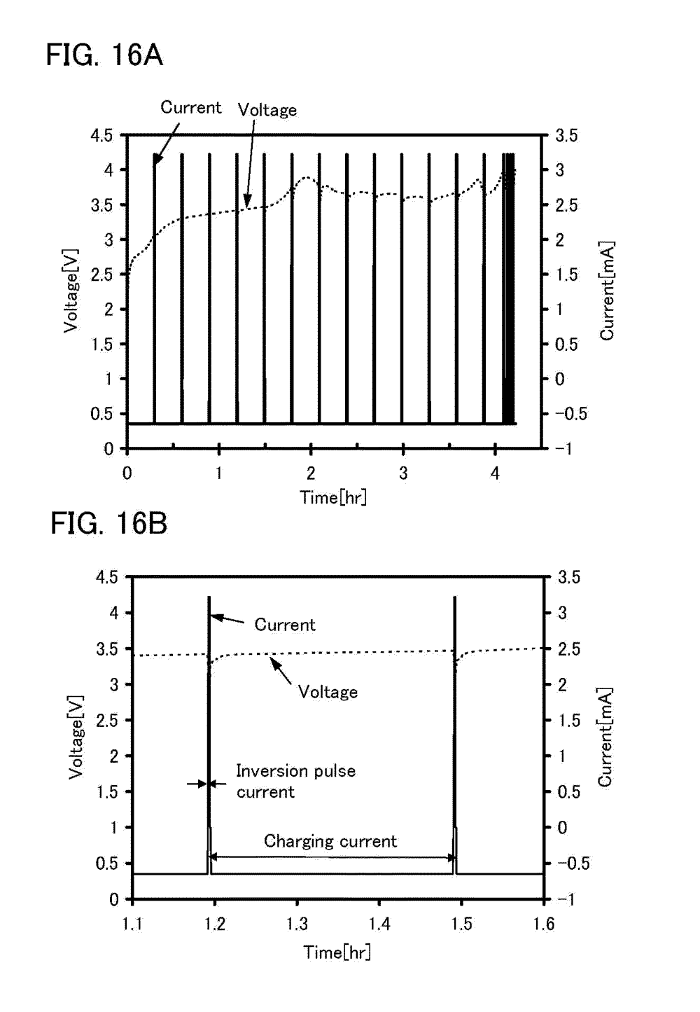

FIG. 16A shows the waveform of the inversion pulse current signal supplied to the positive electrode from outside of the battery for 10 seconds for one supply period. The direction of a current that flows to the positive electrode from outside of the battery and flows to outside of the battery from the negative electrode is assumed to be the positive direction. In other words, the direction in which the inversion pulse current flows in charging is assumed to be the positive direction. FIG. 16A also shows changes in the voltage of Evaluation Cell 1 during the supply of the current signal. The horizontal axis represents time (unit: hour (time)), the longitudinal axis (on the left side) represents voltage (unit: V) of Evaluation Cell 1, and the longitudinal axis (on the right side) represents current (unit: mA). Here, the voltage of Evaluation Cell 1 (also referred to as cell voltage) refers to the potential of the positive electrode relative to the potential of the negative electrode (the potential difference between the positive electrode and the negative electrode).

FIG. 16B is an enlarged graph showing the range of 1.1 hours to 1.6 hours in FIG. 16A. Shot-time discharge is performed at intervals of 0.294 hours. The inversion pulse current at the time of charging the battery is a discharging current; thus, the cell voltage decreases in a period when charge is performed and the inversion pulse current flows.

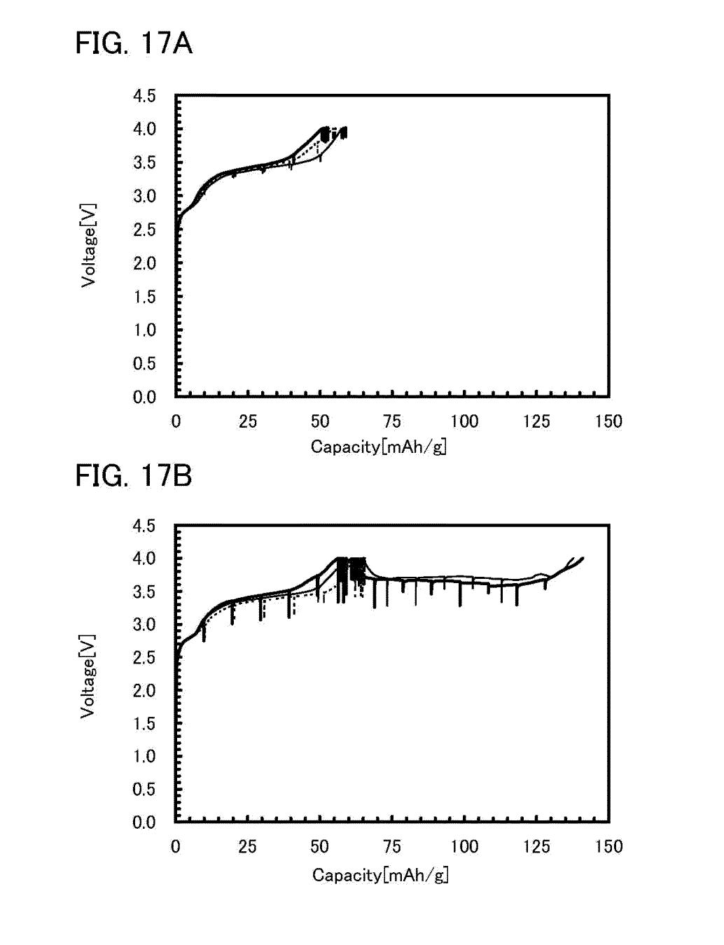

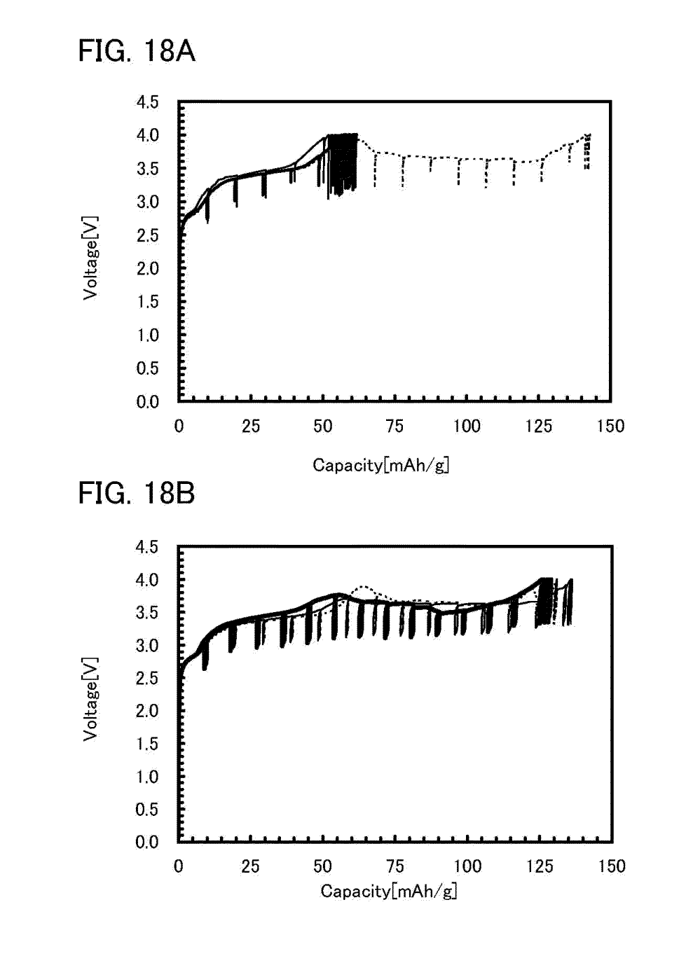

Graphs of FIGS. 17A and 17B and FIGS. 18A and 18B show charge results of the cases where the inversion pulse current supply time was 0 seconds, 1 second, 5 seconds, and 10 seconds. In each graph, the horizontal axis represents the charge capacity (mAh/g) of Evaluation Cell 1, and the longitudinal axis represents the voltage (unit: V) of Evaluation Cell 1. Measurement was performed three times for each case and variations in characteristics were evaluated. In FIGS. 16A and 16B, the horizontal axis represents time, and one voltage value and one current value are plotted with respect to time and the data over time are plotted in the right direction of the graphs. On the other hand, in FIGS. 17A and 17B and FIGS. 18A and 18B, the horizontal axis represents the charge capacity (mAh/g) of Evaluation Cell 1, and even when time passes, the charge capacity of Evaluation Cell 1 is temporarily reduced by supply of the inversion pulse current. Therefore, in FIGS. 17A and 17B and FIGS. 18A and 18B, since the charge capacity increases over time, the data are plotted in the right direction of the graphs; however, supply of the inversion pulse current temporarily reduce the charge capacity of Evaluation Cell 1 and data in the graphs is plotted in the left direction (however, a reduction in the charge capacity in a period when the inversion pulse current flows is too small, so that it cannot be visually recognized in FIGS. 17A and 17B and FIGS. 18A and 18B). When the charging current flows again, the charge capacity of Evaluation Cell 1 increases over time and the data are plotted in the right direction of the graph.

FIG. 17A shows a result of the case where the inversion pulse current supply time was 0 seconds, that is, the case where the inversion pulse current was not supplied in charging. In this case, charge was terminated when the charge capacity reached approximately 60 mAh/g, and each of the three measurement results was low charge capacity. These results indicate that battery deterioration cannot be prevented by a normal charging method.

In contrast, FIG. 17B shows that the charge capacity was approximately 140 mAh/g when the inversion pulse current is supplied for 1 second, and charge was able to be normally performed. However, there was a tendency that the voltage approximated to a termination voltage of 4.0 V at a charge capacity of approximately 60 mAh/g, and charge was terminated in one of the three measurements.

As shown in FIG. 18A, charge was able to be normally performed in the case where the inversion pulse current supply time was 5 seconds. In two of the three measurements, the charge capacity was low as in the case where the inversion pulse current supply time was 1 second.

As shown in FIG. 18B, in the case where the inversion pulse current supply time (pulse width) was 10 seconds, the charge capacity was a normal value in all the three measurements. The cell voltage at the end of charge did not significantly approximate to a termination voltage of 4.0 V at a capacity of approximately 60 mAh/g and charge proceeded.

The above results show that in the case where the inversion pulse current was supplied more than once in charging, a decrease in the capacity at the end of charge can be inhibited as compared with the case of normal charge. The above results also show that under the above charging conditions, charge was able to be stably performed in the case where the inversion pulse current supply time was longer than or equal to 10 seconds. Such results were able to be obtained presumably because resistance increased in charging was able to be reduced by supplying the inversion pulse current to Evaluation Cell 1 more than once in charging. Specifically, the supply of the inversion pulse current dissolved lithium deposited on the negative electrode into the electrolytic solution, which presumably inhibited an increase in the resistance of the negative electrode.

The case of charge is described in this embodiment, and the inversion pulse current may be supplied in discharging as in discharging.

### Example 2

In this embodiment, the fact that formation of a reaction product can be inhibited by an inversion pulse current will be described.

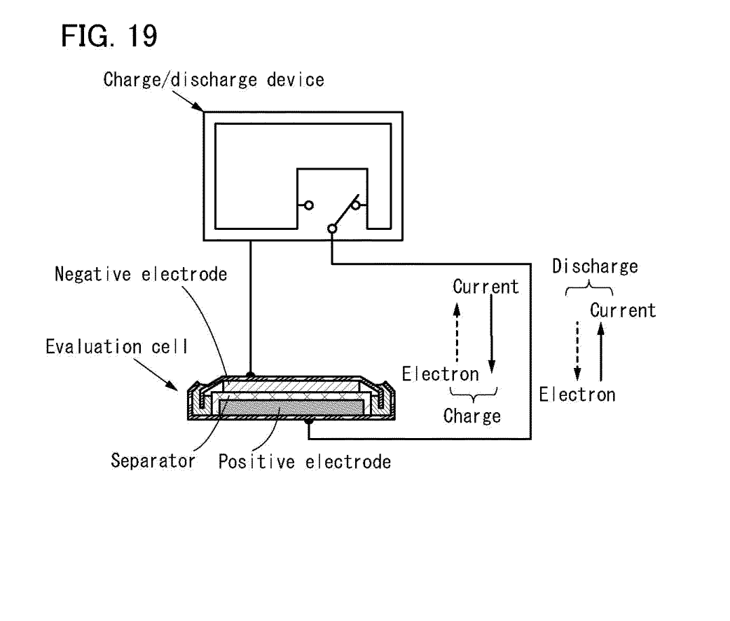

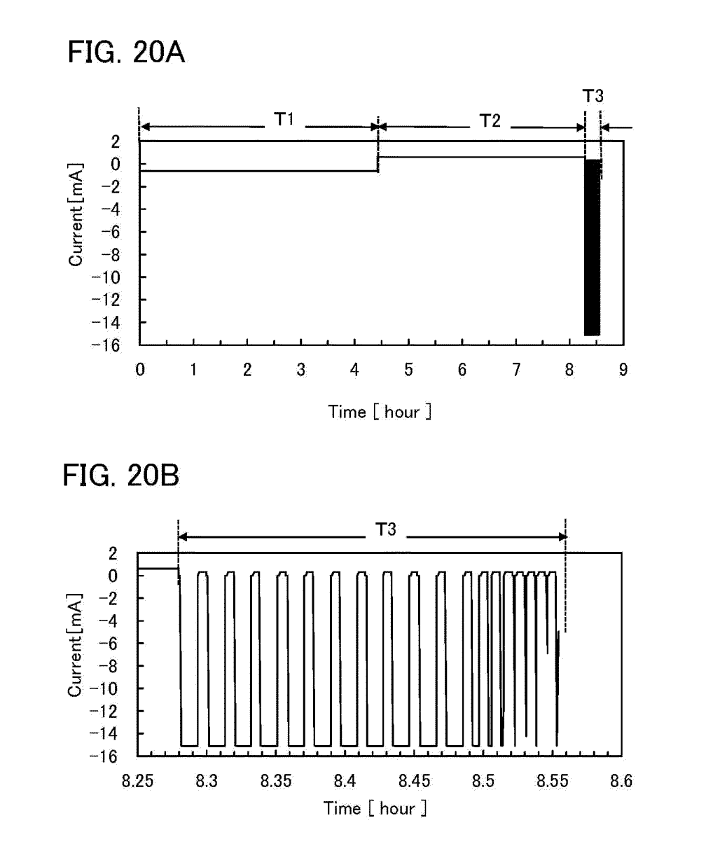

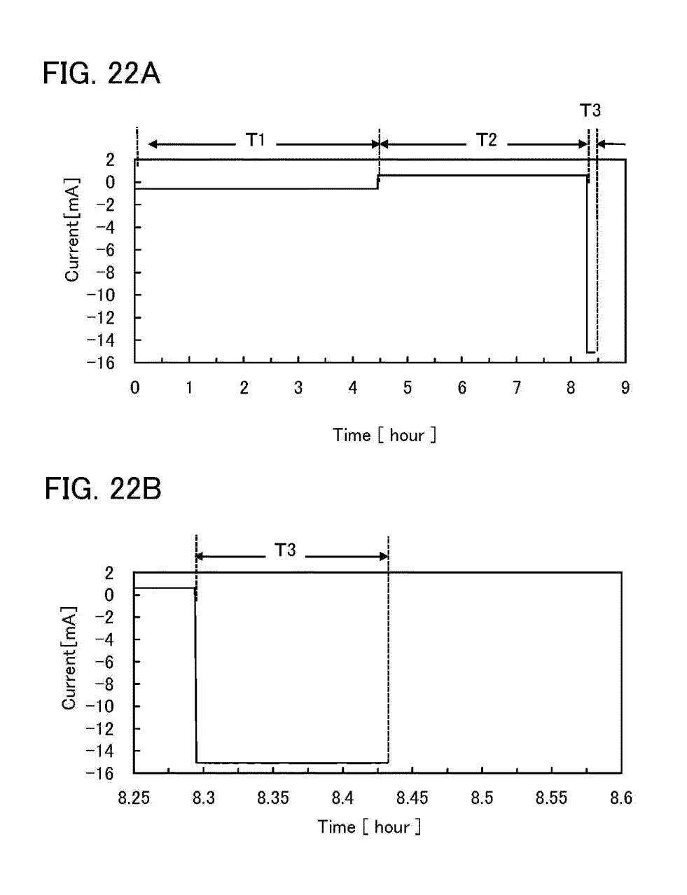

Specifically, the fact that formation of a reaction product including whiskers on a surface of a negative electrode was able to be inhibited by supplying an inversion pulse current in charging a lithium-ion secondary battery will be described with reference to FIG. 19, FIGS. 20A and 20B, FIGS. 21A to 21C, FIGS. 22A and 22B, FIGS. 23A to 23C, and FIGS. 24A and 24B. FIGS. 22A and 22B, FIGS. 23A to 23C, and FIG. 24B show results of comparative examples.

### <Fabrication of Evaluation Cell 2>

In this example, a coin-type lithium-ion secondary battery was fabricated as in Example 1. This lithium-ion secondary battery is referred to as “Evaluation Cell 2”. As illustrated in FIG. 19, Evaluation Cell 2 includes a positive electrode, a negative electrode, and a separator between the positive electrode and the negative electrode. A space between the positive electrode and the negative electrode is filled with an electrolytic solution.

### (Negative Electrode)

A material used for a negative electrode active material was obtained by forming a silicon oxide film on a surface of graphite spherulites with a particle size distribution D50 (the particle size when the integrated amount of particles in an integrated particle amount curve of a particle size distribution measurement result is 50% of the total amount of particles) of 9 μm. The graphite whose surface was provided with the silicon oxide film was formed as follows.

Silicon ethoxide (3.14×10⁻⁴ mol) and ethyl acetoacetate (6.28×10⁻⁴ mol) were dissolved in toluene (2 ml) to form a solution. Graphite was added to this solution so that the weight of silicon oxide with respect to the weight of graphite was 1 wt %, and the mixed solution was held at 70° C. in a humid environment for 3 hours so that the silicon ethoxide was hydrolyzed. Then, baking was performed at 500° C. in a nitrogen atmosphere for 3 hours, so that the graphite whose surface was provided with the silicon oxide film was formed.

The graphite, polyvinylidene fluoride (PVDF), and N-methyl-2-pyrrolidone (NMP) were mixed to form a slurry. At this time, the weight ratio of the graphite to the PVDF was 90:10. The slurry was applied over a current collector (18-μm-thick copper foil) and dried to form an electrode. This electrode was stamped into a round shape with a diameter of 16.16 mm, so that the negative electrode of Evaluation Cell 2 was formed.

The thickness of the negative electrode was 45 μm, and the weight of the negative electrode active material was 10.350 mg. Note that the theoretical capacity of the graphite was 372 mAh/g.

### (Positive Electrode)

Lithium iron phosphate (LiFePO₄) particles with a size distribution D90 (the particle size when the integrated amount of particles in an integrated particle amount curve of a size distribution measurement result is 90% of the total amount of particles) of 1.7 μm was used for a positive electrode active material. LiFePO₄, graphehe oxide (GO), PVDF, and NMP were mixed to form a slurry. The GO was formed by a Hummers method using flaky graphite particles with an average diameter of 40 μm as a material. The weight ratio of LiFePO₄ to GO and PVDF was 91.4:0.6:8. This slurry was applied over a current collector (20-μm-thick aluminum foil) and dried, and heat treatment was performed at 170° C. under reduced pressure for 10 hours to reduce the GO, so that an electrode was formed. This electrode was stamped into a round shape with a diameter of 15.96 mm, so that a positive electrode of Evaluation Cell 2 was formed.

The thickness of the positive electrode was 52 μm, and the weight of the positive electrode active material was 17.613 mg. Note that the capacity of the positive electrode with respect to the capacity of the negative electrode was 77.8%.

### (Electrolytic Solution)

An electrolytic solution was formed by dissolving lithium hexafluorophosphate (LiPF₆) in a mixed solvent of ethylene carbonate (EC) and diethyl carbonate (DEC). The EC and the DEC were mixed at a volume ratio of 3:7, and LiPF₆ was dissolved at a concentration of 1 mol/L.

### (Separator)

A glass fiber filter with a thickness of 260 μm was used as a separator.

### <Experiment: Charge and Discharge of Evaluation Cell 2>

In this example, first, initial charge was performed without supplying an inversion pulse current. Then, discharge was performed without supplying an inversion pulse current. After that, second charge was performed. In the second charge, the inversion pulse current was supplied more than once. The charge and discharge were performed with Evaluation Cell 2 connected to a charge/discharge device as illustrated in FIG. 19. Note that the environmental temperature was 25° C.

Further, 1 C, which means the amount of current with which the total capacity of Evaluation Cell 2 is discharged in an hour, was calculated from the weight of the positive electrode active material (17.613 mg) and the theoretical capacity of LiFePO₄ (170 mAh/g). The charge rate and the discharge rate (unit: C) of Evaluation Cell 2 were set relative to 1 C.

FIG. 20A shows changes over time of current supplied to Evaluation Cell 2. Here, the direction in which the inversion pulse current flows in charging, that is, the direction of a current that flows from the positive electrode to outside of the battery, is assumed to be the positive direction. Thus, the value of current with which Evaluation Cell 2 was charged is negative, and the value of current with which Evaluation Cell 2 was discharged (discharging current) is positive. In the other graphs, current values are represented in a similar manner.

In FIG. 20A, the period T1 represents an initial charge period, the period T2 represents an initial discharge period; and the period T3 represents a second charge period. In the period T3, charge was performed by alternately supplying a charging current and the inversion pulse current more than once. FIG. 20B is an enlarged graph showing a part of the period T3 in FIG. 20A.

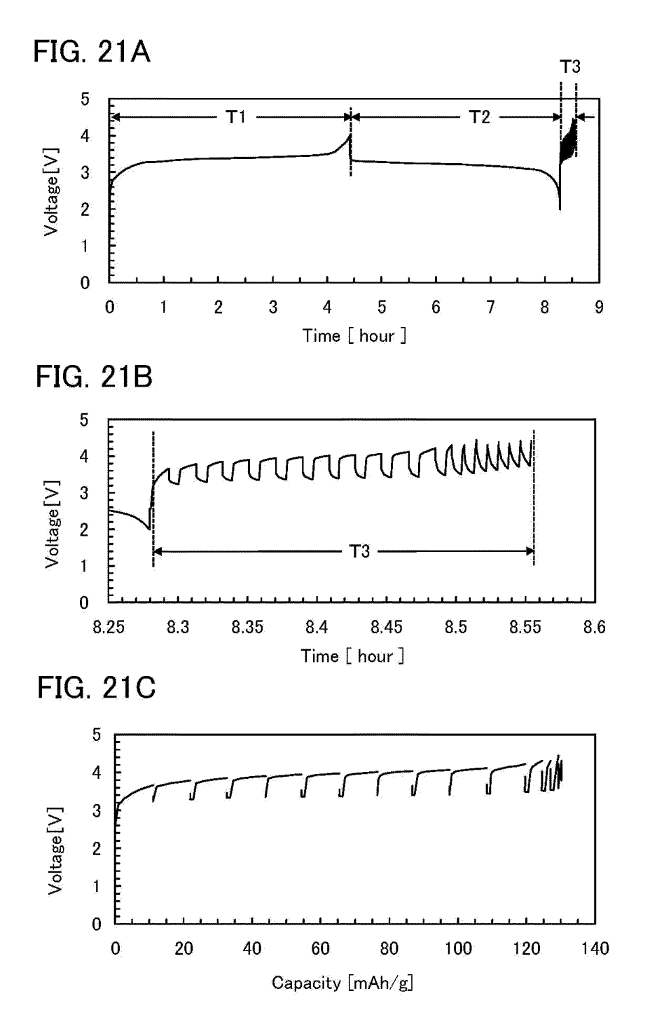

FIG. 21A shows changes over time in the voltage of Evaluation Cell 2 in a period during which a current is supplied in FIG. 20A. FIG. 21B is an enlarged graph showing a part of the period T3 in FIG. 21A. The voltage of Evaluation Cell 2 is specifically a voltage (cell voltage) between the positive electrode and the negative electrode; here, it is the potential of the positive electrode relative to that of the negative electrode.

### (Period T1: Initial Charge)

Initial charge was performed at a rate of 0.2 C (0.605 mA) (FIG. 20A). The charge was stopped when the cell voltage reached 4.0 V (FIG. 21A).

### (Period T2: Initial Discharge)

Initial discharge was performed at a rate of 0.2 C (FIG. 20A). The discharge was stopped when the cell voltage decreased to 2.0 V (FIG. 21A).

### (Period T3: Second Charge)

Second charge was performed by alternately supplying the charging current and the inversion pulse current to Evaluation Cell 2. The charge was performed at a rate as high as a rapid charging rate. Specifically, after a charging current was supplied to Evaluation Cell 2 at a rate of 5 C (15.1 mA) so that energy of 10 mAh/g (0.176 mAh) of the total capacity was stored, the inversion pulse current was supplied to Evaluation Cell 2 at a rate of 0.1 C (0.299 mA) for 20 seconds (FIG. 20B). The charge was stopped when the cell voltage reached 4.3 V (FIG. 21B).

The inversion pulse current in the period T3 is a current that flows in the reverse direction of a current with which a reaction of lithium intercalation into graphite (negative electrode active material) occurs and flows in the reverse direction of a current with which a reaction product is formed (see FIG. 3A).

FIG. 21C shows changes in the voltage (cell voltage) of Evaluation Cell 2 with respect to charge capacity per unit weight of the positive electrode active material in the period T3.

### <Observation of Negative Electrode>

After the second charge, Evaluation Cell 2 was disassembled in a glove box in an argon atmosphere, and the negative electrode taken out of Evaluation Cell 2 was washed with dimethyl carbonate. Then, the negative electrode was carried into a scanning electron microscope (SEM) using an atmosphere barrier holder and the surface of the negative electrode was observed.

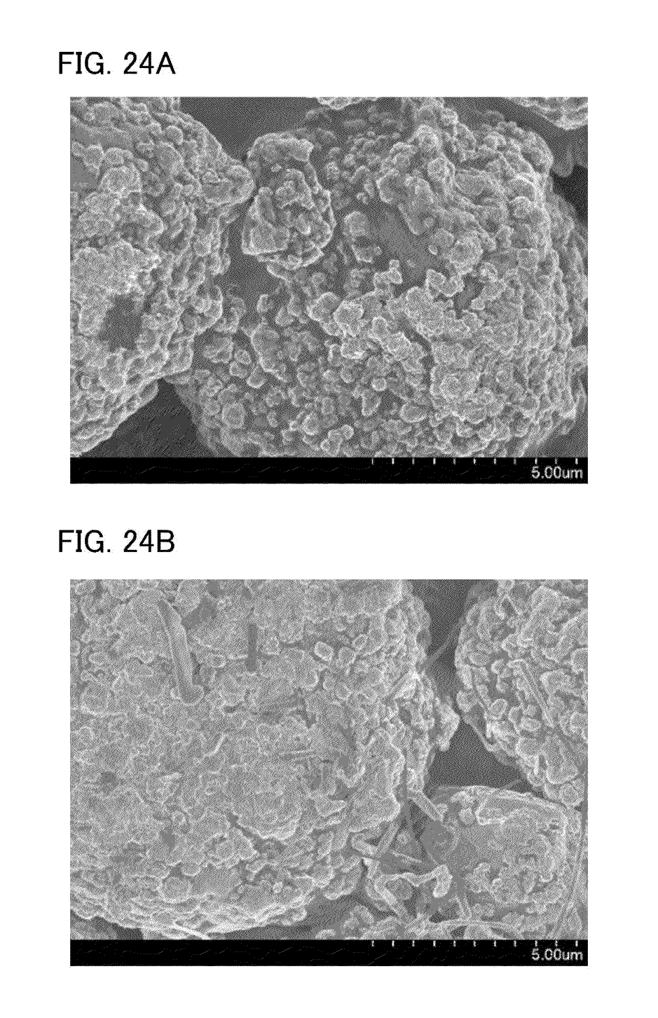

FIG. 24A shows a SEM secondary electron image of the surface of the negative electrode of Evaluation Cell 2. A spherical substance in FIG. 24A is graphite used for the negative electrode active material. A reaction product including whiskers was not observed on the surface of the graphite.

As a comparative example, a coin-type lithium-ion secondary battery charged at a rate of 5 C without supplying an inversion pulse current in second charge will be described. In the comparative example, a reaction product including whiskers was observed on the surface of graphite used for a negative electrode active material.

The results in this example show an innovative effect that the reaction product including whiskers was dissolved by electrically stimulating the reaction product, specifically, supplying a signal (inversion pulse current) with which a current flows in the reverse direction of a current with which a reaction product is formed.

### Comparative Example

A comparative example will be described below.

### <Structure of Comparative Cell>

In this comparative example, a coin-type lithium-ion secondary battery having the same structure as that of the coin-type lithium-ion secondary battery in Example 2 was evaluated. The lithium-ion secondary battery used in the comparative example is referred to as a “comparative cell”. The comparative cell was fabricated like Evaluation Cell 2. Note that the comparative cell is different from Evaluation Cell 2 in the capacity of a positive electrode.

In the comparative cell, the thickness of a negative electrode was 45 μm and the weight of a negative electrode active material was 10.530 mg. Further, the thickness of the positive electrode was 54 μm and the weight of a positive electrode active material was 18.070 mg. The capacity of the positive electrode with respect to the capacity of the negative electrode was 78.4%.

### <Experiment: Charge and Discharge of Comparative Cell>

FIGS. 22A and 22B show a current supplied to the comparative cell.

In FIG. 22A, the period T1 represents an initial charge period, the period T2 represents an initial discharge period; and the period T3 represents a second charge period. In the period T3, only a charging current was supplied and an inversion pulse current was not supplied to the comparative cell. FIG. 22B is an enlarged graph showing a part of the period T3 in FIG. 22A.

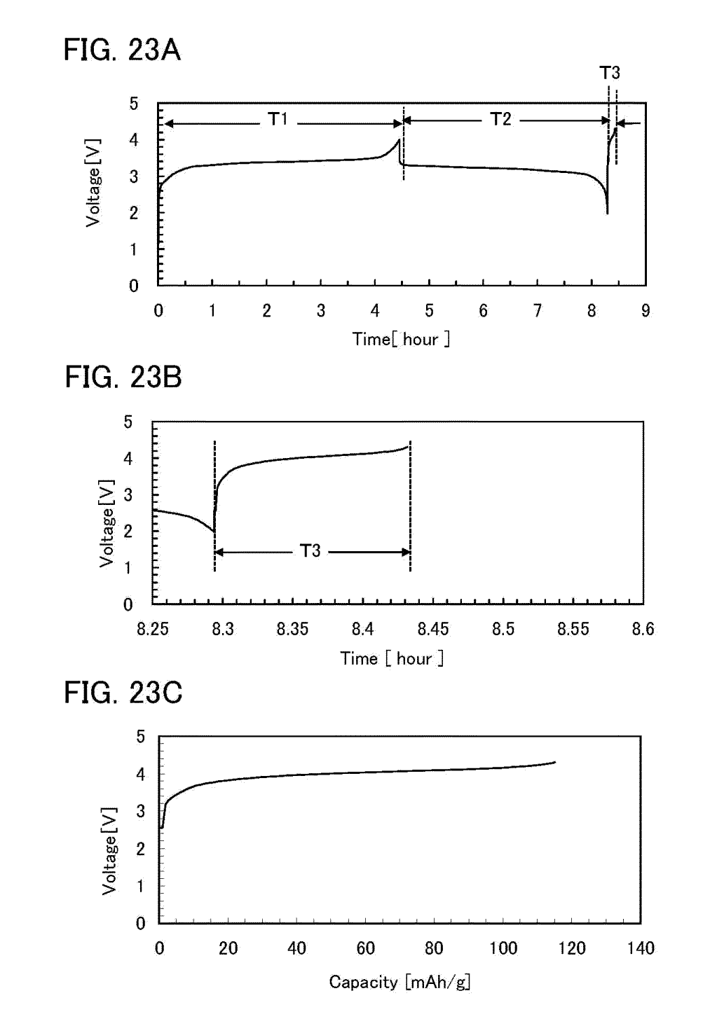

FIG. 23A shows changes over time in the voltage of the comparative cell in a period during which a current is supplied in FIG. 22A. FIG. 23B is an enlarged graph showing a part of the period T3 in FIG. 23A. FIG. 23C shows changes in the voltage of the comparative cell with respect to charge capacity per unit weight of the positive electrode active material in the period T3.

### (Period T1: Initial Charge)

Initial charge was performed in a manner similar to that of Evaluation Cell 2. The charge was performed at a rate of 0.2 C and stopped when the cell voltage reached 4.0 V (FIG. 22A and FIG. 23A).

### (Period T2: Initial Discharge)

Initial discharge was also performed in a manner similar to that of Evaluation Cell 2. The discharge was performed at a rate of 0.2 C and stopped when the cell voltage reached 2.0 V (FIG. 22A and FIG. 23A).

### (Period T3: Second Charge)

The comparative cell was charged under the same conditions as those for Evaluation Cell 2 except that the inversion pulse current is not supplied. Specifically, the charge was performed at a rate of 5 C and stopped when the cell voltage reached 4.3 V (FIG. 22B and FIG. 23B).

The result of Evaluation Cell 2 in FIG. 20B and the result of Comparative Example 2 in FIG. 22B show that the second charge of the comparative cell was terminated in a shorter time than Evaluation Cell 2. In addition, the result of Evaluation Cell 2 in FIG. 21C and the result of Comparative Example 2 in FIG. 23C show that the charge capacity of the comparative cell at the time when the charge was terminated was lower than that of Evaluation Cell 2.

### <Observation of Negative Electrode>

After the second charge, the comparative cell was disassembled like Evaluation Cell 2, and the surface of the negative electrode was observed using a scanning electron microscope (SEM).

FIG. 24B shows a SEM secondary electron image of the surface of the negative electrode. A spherical substance in FIG. 24B is graphite used for the negative electrode active material. A reaction product including whiskers that covers the surface of the graphite was observed. This reaction product is presumably one of causes of a reduction in the charge capacity of the comparative cell.

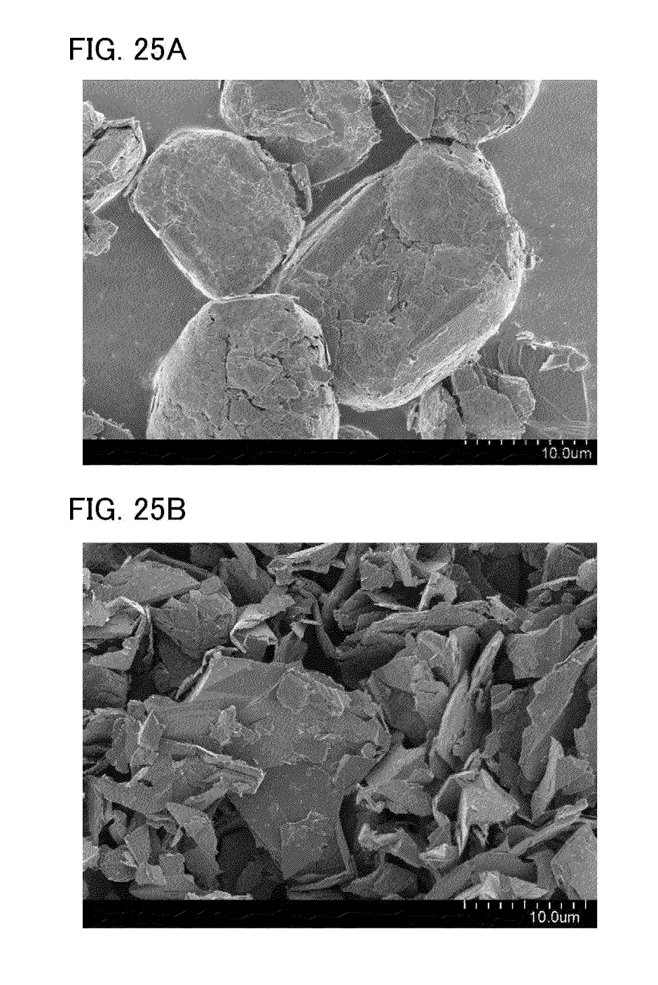

In this example, graphite spherulites were used as the negative electrode active materials of Evaluation Cell 2 and the comparative cell; however, the shape of graphite is not particularly limited. For example, spherical natural graphite shown in a SEM secondary electron image in FIG. 25A or flaky graphite shown in a secondary electron image in FIG. 25B may be used. Depending on the shape of graphite, the deposition position or size of lithium including whiskers varies in some cases. Regardless of the shape of graphite used for a negative electrode, the present invention can be applied to any battery in which lithium is deposited. By supplying an inversion pulse current between a positive electrode and a negative electrode one or more times in charging or discharging, ideally, a surface of the electrode can be restored to the initial state where a reaction product is not deposited on the surface of the electrode.

### EXPLANATION OF REFERENCE

10: battery, 12: positive electrode, 13: electrolytic solution, 14: negative electrode, 15: separator, 101: negative electrode, 103: electrolytic solution, 201: negative electrode, 203: electrolytic solution, 301: negative electrode, 303: electrolytic solution, 304: protective film

This application is based on Japanese Patent Application serial no. 2013-004160 filed with the Japan Patent Office on Jan. 14, 2013 and Japanese Patent Application serial no. 2013-031147 filed with the Japan Patent Office on Feb. 20, 2013, the entire contents of which are hereby incorporated by reference.

1. An electrochemical device comprising:
a first electrode that includes a first layer including a first active material;
a second electrode that includes a second layer including a second active material; and
an electrolytic solution between the first electrode and the second electrode,
wherein a reaction product is not substantially deposited on a surface of the first electrode or the second electrode.

2. The electrochemical device according to claim 1,
wherein the first active material includes a metal element, and
wherein the metal element is not substantially deposited on the surface of the second electrode.

3. The electrochemical device according to claim 1,
wherein the first active material includes a metal element that is released as a positive ion in charging, and
wherein the metal element is not substantially deposited on the surface of the second electrode.

4. A method for charging and discharging an electrochemical device, the electrochemical device comprising:
a first electrode that includes a first layer including a first active material;
a second electrode that includes a second layer including a second active material; and
an electrolytic solution between the first electrode and the second electrode,
the method comprising the steps of:
supplying a first current between the first electrode and the second electrode in a first direction; and
supplying a second current between the first electrode and the second electrode in a reverse direction of the first direction,
wherein the first current and the second current flow alternately and repeatedly, and
wherein one period in which the second current flows is shorter than one period in which the first current flows.

5. The method for charging and discharging an electrochemical device, according to claim 4,
wherein the one period in which the second current flows is longer than or equal to one hundredth of the one period in which the first current flows and shorter than or equal to one third of the one period in which the first current flows.

6. The method for charging and discharging an electrochemical device, according to claim 4,
wherein the one period in which the second current flows is longer than or equal to 0.1 seconds and shorter than or equal to 3 minutes.

7. The method for charging and discharging an electrochemical device, according to claim 4,
wherein the one period in which the second current flows is longer than or equal to 3 seconds and shorter than or equal to 30 seconds.
